(19) United States
(12) Patent Application Publication
(10) Pub. No.: US 2025/0138786 A1
(43) Pub. Date: May 1, 2025

(54) ADAPTIVE NO-CODE DEVELOPMENT SYSTEM

(71) Applicants: Gareth Thomas Edge, Epsom (GB); Jason Anthony Edge, Surbiton (GB); Nicolo' Sgobba, Fasano (IT); William Carbone, Cittanova (IT)

(72) Inventors: Gareth Thomas Edge, Epsom (GB); Jason Anthony Edge, Surbiton (GB); Nicolo' Sgobba, Fasano (IT); William Carbone, Cittanova (IT)

(21) Appl. No.: 18/932,509

(22) Filed: Oct. 30, 2024

Related U.S. Application Data
(60) Provisional application No. 63/594,851, filed on Oct. 31, 2023.

(51) Int. Cl. G06F 8/30

(52) U.S. Cl. CPC G06F 8/30

(57) ABSTRACT

Systems disclosed herein facilitate generating no-code applications and enable untrained users to develop no-code applications by using machine learning based recommendation systems to recommend no-code components to users. The systems can recommend no-code components during the development of a no-code application and/or after publication of a no-code application. The systems may recommend replacements of selected no-code components. Further, the systems may recommend configurations or alternative configurations of selected no-code components. The recommendations may be determined by using a prediction model trained using one or more machine learning models or algorithms. In some cases, the prediction model may be an ensemble model that uses the results of a plurality of prediction models or machine learning algorithms to make a recommendation. In some cases, usage information obtained for a no-code application can be used to generate recommendations to improve a no-code application with respect to an identified goal for the no-code application.

### INCORPORATION BY REFERENCE

This application claims priority to U.S. Provisional Application No. 63/594,851, filed on Oct. 31, 2023, which is hereby incorporated by reference in its entirety for all purposes. Any and all applications for which a foreign or domestic priority claim is identified in the Application Data Sheet as filed with the present application are hereby incorporated by reference under 37 CFR 1.57.

### TECHNICAL FIELD

The present disclosure relates to no-code applications that are developed without a user directly writing source code. More specifically, the present disclosure relates to an adaptive no-code development that improves the accuracy and efficiency of no-code applications over time that are developed using the systems described herein.

### BACKGROUND

Developing and writing software applications can be complicated and often requires significant training and experience. In order to program a software application, it has often been the case that one learns a programming language, which can be difficult for some people to learn. Recently, there have been developments that enable a person to develop a software application with minimal training. One such development is the use of code abstractions that permit a user to drag an icon representing an action onto a digital workspace. The icon can represent software code and the code may be written for the user as they position the icons into the workspace.

### SUMMARY

The systems, methods and devices of this disclosure each have several innovative aspects, no single one of which is solely responsible for all of the desirable attributes disclosed herein. Details of one or more implementations of the subject matter described in this specification are set forth in the accompanying drawings and the description below.

In some aspects, the techniques described herein relate to a no-code development system configured to recommend a no-code component to a user during development of an application, the no-code development system including: a non-volatile memory configured to store an application playbook including a set of coding events; and a hardware processor in communication with the non-volatile memory, the hardware processor configured to: receive an indication of a no-code component being added to an application canvas; add the indication of the no-code component to the application playbook as a coding event, wherein the coding event corresponds to a creation of a portion of the application without the user writing source code; apply the application playbook to a component prediction model to identify a second no-code component, wherein the component prediction model includes a machine-learning based prediction model configured to identify no-code components based at least in part on a portion of an application under development; output an identification of the second no-code component to the user; receive a selection of the second no-code component; and add an instance of the second no-code component to the application canvas.

In some aspects, the techniques described herein relate to a no-code development system, wherein the second no-code component is an instance of the no-code component, and wherein the identification of the second no-code component includes an identification of a configuration of a parameter of the no-code component.

In some aspects, the techniques described herein relate to a no-code development system, wherein the hardware processor is further configured to receive an indication of a purpose of the application, and wherein applying the application playbook to the component prediction model further includes applying the indication of the purpose of the application to the component prediction model.

In some aspects, the techniques described herein relate to a no-code development system, wherein adding the instance of the second no-code component to the application canvas includes replacing the no-code component with the second no-code component.

In some aspects, the techniques described herein relate to a no-code development system, wherein the hardware processor is further configured to: add the indication of the second no-code component to the application playbook to obtain an updated application playbook; apply the updated application playbook to the component prediction model to identify a third no-code component; and output an identification of the third no-code component to the user.

In some aspects, the techniques described herein relate to a no-code development system, wherein, in response to receiving an indication that the third no-code component was not selected to add to the application canvas, the hardware processor is further configured to modify the updated application playbook to indicate the non-selection of the third no-code component.

In some aspects, the techniques described herein relate to a no-code development system, wherein the component prediction model is trained based at least in part on previously created applications created using the no-code development system.

In some aspects, the techniques described herein relate to a no-code development system configured to modify a no-code application, the no-code development system including: a non-volatile memory configured to store computer-executable instructions; and a hardware processor in communication with the non-volatile memory and configured to execute the computer-executable instructions to at least: receive an identity of a no-code component; receive a configuration value for a characteristic of the no-code component, wherein the characteristic corresponds to operation of the no-code component or a location of the no-code component within the no-code application; using a prediction model, determine a recommended no-code component based at least in part on the identity of the no-code component and the configuration value; and output an indication of the recommended no-code component.

In some aspects, the techniques described herein relate to a no-code development system, wherein outputting the indication of the recommended no-code component includes outputting an indication of the no-code component on a user interface for display to a user.

In some aspects, the techniques described herein relate to a no-code development system, wherein outputting the indication of the recommended no-code component includes automatically replacing the no-code component with the recommended no-code component within the no-code application without action by a user.

In some aspects, the techniques described herein relate to a no-code development system, wherein the recommended no-code component includes a different no-code component than the no-code component.

In some aspects, the techniques described herein relate to a no-code development system, wherein the recommended no-code component includes an instance of the no-code component with a different configuration value for the characteristic of the no-code component.

In some aspects, the techniques described herein relate to a no-code development system, wherein the prediction model is trained using at least a plurality of no-code applications.

In some aspects, the techniques described herein relate to a no-code development system, wherein the hardware processor is further configured to execute the computer-executable instructions to at least receive an indication of an application goal of the no-code application.

In some aspects, the techniques described herein relate to a no-code development system, wherein the recommended no-code component is further determined based at least in part on the application goal.

In some aspects, the techniques described herein relate to a no-code development system, wherein the hardware processor is further configured to execute the computer-executable instructions to at least access usage statistics of the no-code application.

In some aspects, the techniques described herein relate to a no-code development system, wherein the usage statistics are obtained from an application playback configured to track events corresponding to interaction with the no-code application.

In some aspects, the techniques described herein relate to a no-code development system, wherein the usage statistics are obtained by tracking interaction with the no-code application over a time period.

In some aspects, the techniques described herein relate to a no-code development system, wherein the hardware processor is further configured to execute the computer-executable instructions to at least recommend a modification to the no-code component based at least in part on the application goal and the usage statistics.

In some aspects, the techniques described herein relate to a no-code development system, wherein the modification to the no-code component includes a modification to the configuration value of the no-code component.

In some aspects, the techniques described herein relate to a no-code development system, wherein the modification to the no-code component includes an identity of a replacement no-code component for the no-code component.

In some aspects, the techniques described herein relate to a no-code development system, wherein the hardware processor is further configured to execute the computer-executable instructions to at least update training of the prediction model based at least in part on the usage statistics.

In some aspects, the techniques described herein relate to a no-code development system, wherein the location of the no-code component within the no-code application corresponds to a location within a user interface of the no-code application.

In some aspects, the techniques described herein relate to a no-code development system, wherein the prediction model includes a plurality of prediction models.

In some aspects, the techniques described herein relate to a no-code development system, wherein determining the recommended no-code component includes: obtaining a set of prediction values the plurality of prediction models, wherein the set of prediction values includes at least one prediction value from each prediction model of the plurality of prediction models; determining a consensus prediction value based at least in part on the set of prediction values; and determining the recommended no-code component based at least in part on the consensus prediction value.

In some aspects, the techniques described herein relate to a no-code development system, wherein each prediction model is generated using a different machine learning model.

In some aspects, the techniques described herein relate to a no-code development system, wherein the prediction model is generated based at least in part on training data corresponding to a set of no-code applications and a set of objective weights corresponding to one or more applications goals.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure. In addition, various features of different disclosed embodiments can be combined to form additional embodiments, which are part of this disclosure. Further, one or more features or structures can be removed or omitted.

FIG. 1 illustrates an overview of a no-code development system for developing and interacting with no-code applications in accordance with certain embodiments.

FIG. 2 illustrates a flow diagram illustrating user interaction with the no-code development system in accordance with certain embodiments.

FIG. 3 illustrates an example of a user interface that can be used by the no-code builder to design a no-code application in accordance with certain embodiments.

FIG. 4 illustrates an example of a portion of a component library that can be used by the no-code builder to design a no-code application in accordance with certain embodiments.

FIG. 5 illustrates an example of the component properties panel with example values for a map component in accordance with certain embodiments.

FIG. 6 illustrates the output of the no-code map component illustrated in FIG. 5 at runtime as part of the no-code application in accordance with certain embodiments.

FIG. 7 illustrates an example of an application navigator pane that may be included as part of the user interface illustrated in FIG. 3 in accordance with certain embodiments.

FIG. 8 illustrates example application playbook entries associated with components added to the no-code application in accordance with certain embodiments.

FIG. 9 presents a flowchart of an example no-code application improvement recommendation process in accordance with certain embodiments.

FIG. 10 presents a flowchart of an example embodiment of generating no-code component recommendations based on context in accordance with certain embodiments.

FIG. 11 presents a flowchart of one non-limiting example of a no-code component recommendation process that uses user input to identify no-code components to recommend in accordance with certain embodiments.

FIG. 12 presents a flowchart of one non-limiting example of recommending no-code component configurations based at least in part on implemented no-code application components in accordance with certain embodiments.

FIG. 13 presents a flowchart of one non-limiting example use-case of using application user data to improve an application in accordance with certain embodiments.

FIG. 14 illustrates a flowchart of a non-limiting example process of incorporating user feedback into the application playbook.

FIG. 15 illustrates an interactive computing environment in accordance with certain embodiments.

FIG. 16 presents a flowchart of a non-limiting example application build process in accordance with certain embodiments.

FIG. 17 presents a flowchart of a non-limiting example application refinement process in accordance with certain embodiments.

FIG. 18 presents a flowchart of a non-limiting example recommendation model training process in accordance with certain embodiments.

### DETAILED DESCRIPTION OF CERTAIN EMBODIMENTS

The headings provided herein, if any, are for convenience only and do not necessarily affect the scope or meaning of the claimed invention.

The use of abstractions representing code blocks can simplify the programming process. One such abstraction are no-code blocks or components. The no-code blocks may correspond to actions, operations, user interface elements, or any other object that may be included in a software application. Further, these no-code blocks may be associated with code, but may abstract the code such that a user does not need to see or understand code to use the blocks. Thus, a user can build an application without understanding coding. For example, a user that desires to build a quiz application for a website can position no-code blocks representing user interface elements that can present questions, receive answers, evaluate the answers, keep score, and perform any other operation associated with a quiz application without understanding or in some cases seeing the underlying code for the no-code blocks.

Using no-code blocks to generate applications may lead to inefficiencies due, for example, to a user's lack of understanding of software code, software development methodologies, or of the underlying code represented by the no-code block. Further, because the use of no-code blocks may make it easy for anyone to build an application regardless of training, there is the risk that the application may not operate as desired. For example, an application created to engage a user or to sell products and services may not be effective due to a lack of understanding in design by the developer of the application. Some users may learn over time how to create an application that achieves the goals of the application. However, other users may not or may not have the time to learn because, for example, they require an effective application at the present time. Moreover, although it is possible to hire expert developers, often users cannot afford an expert developer, particularly if the user is a small business.

Embodiments disclosed herein facilitate generating no-code applications. Further, embodiments disclosed herein enable untrained users to develop no-code applications by using machine learning based recommendation systems to recommend no-code components to users. The systems can recommend no-code components during the development of a no-code application and/or after publication of a no-code application. In some embodiments, the systems may recommend replacements of selected no-code components. Further, the systems may recommend configurations or alternative configurations of selected no-code components. The recommendations may be determined by using a prediction model trained using one or more machine learning models or algorithms. In some cases, the prediction model may be an ensemble model that uses the results of a plurality of prediction models or machine learning algorithms to make a recommendation. Further, in some cases, usage information obtained for a no-code application can be used to generate recommendations to improve a no-code application with respect to an identified goal for the no-code application.

In building no-code applications, there are advantages that can be achieved by discerning between the “build-time”, e.g., when no-code builders are designing, building, and configuring no-code components that will compose an application, from the “run-time”, e.g., when application users execute, interact with, or otherwise use the applications generated by the no-code builders.

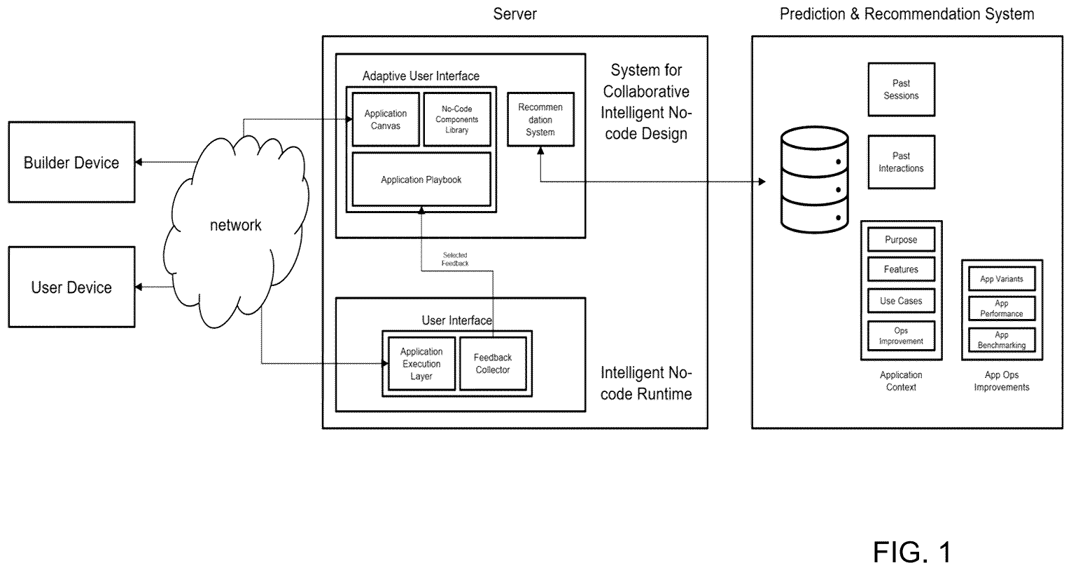

FIG. 1 illustrates an overview of a no-code development system for developing and interacting with no-code applications in accordance with certain embodiments. The no-code development system can include one or more computing systems (e.g., servers) that present user interfaces (e.g., adaptive user interfaces) to one or more user devices for designing and/or interacting with the no-code applications. The user interfaces may be presented to a user of a builder device, which may be a user computing device accessed by a no-code builder. The no-code builder may include any type of user who is designing and building an application using no-code tools.

The user interfaces may further include a runtime user interface that collects usage data from a user device that executes or interacts with the no-code application developed by the user of the builder device. An end user or customer user may interact with the user device to interact with and/or execute the no-code application.

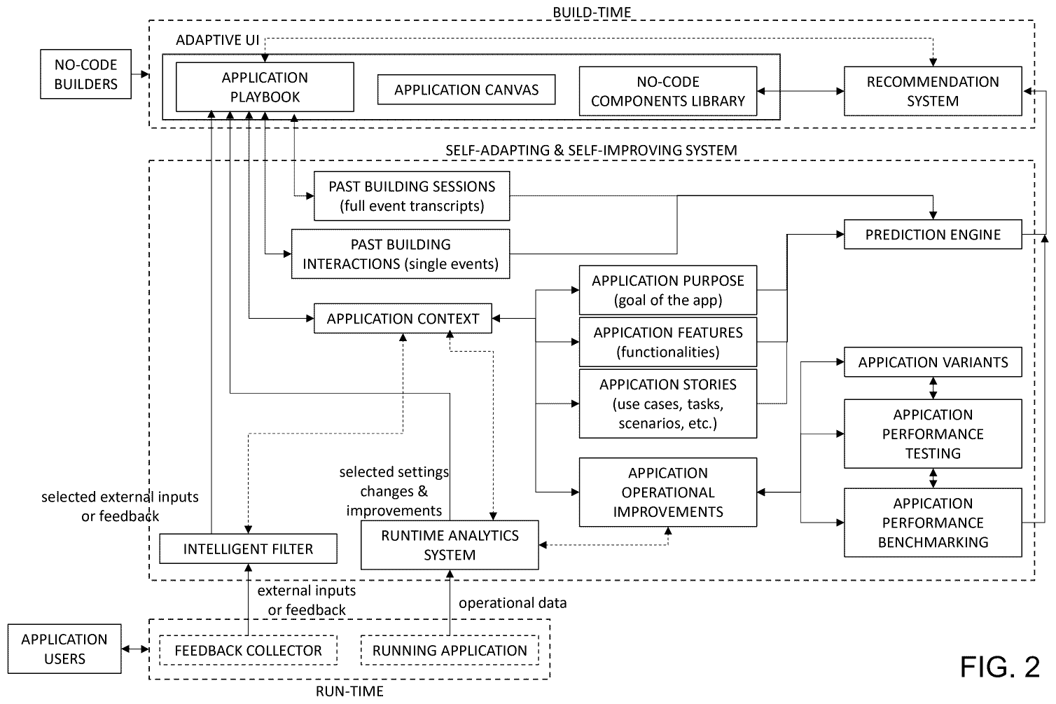

FIG. 2 illustrates a flow diagram illustrating user interaction with the no-code development system in accordance with certain embodiments. A no-code builder may interact with the no-code development system to generate a no-code application. A no-code application may include underlying source code, but the source code of the no-code application may be hidden or not accessible to the no-code builder. In some cases, the no-code builder can view the underlying source code, but access to the underlying source code may be optional in developing the no-code application.

The no-code builder can be considered a software developer of the no-code world. With “no-code”, the aim is to enable anyone to design and deploy applications without knowledge of programming languages and syntax, allowing builders to design what the application will do instead of how it will do it. Instead, the no-code development system will determine the underlying source code, or the “how it will do it” based at least in part on the design information provided by the no-code builder. When building the no-code application, the no-code builder can use blocks or components that represent desired operations that are abstracted from the underlying code. For example, a no-code builder may add a block or component to an application development canvas associated with displaying a carousel of images associated with a product as part of an online retailer application. The component may include a parameter that requests that the no-code builder identify where the images are stored. The underlying source code for implementing the component may be hidden from the no-code builder making it possible for users who do not know how to code to build an application.

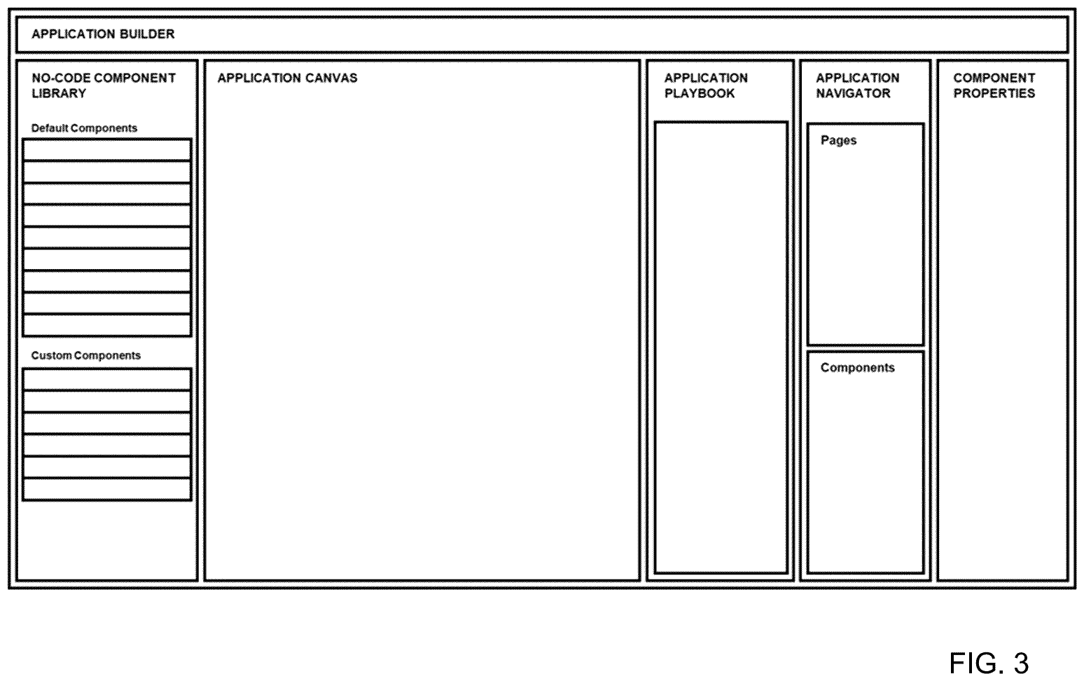

FIG. 3 illustrates an example of a user interface that can be used by the no-code builder to design a no-code application in accordance with certain embodiments. The user interface may be an adaptive user interface that can modify the elements available to the no-code builder based on interaction by the no-code builder or other no-code builders with the user interface.

The user interface may include a no-code components library that can include pre-built and modular elements within the no-code platform that enable users to create, customize, and configure digital applications without the need for manual coding or directly writing source code. For example, the no-code platform may include modular elements for buttons, text fields, forms, images, and navigation menus that can form the visual structure of an application. As another example, the no-code platform can include pre-built modules that enable users to implement conditional statements, loops, and other basic programming constructs to control the application's behavior and automate repetitive tasks. The various pre-built or modular elements can be dragged and dropped onto the application design canvas or otherwise referenced, such as via audio input. Further, when certain blocks have been put together and configured for a particular reproducible set of actions (e.g., a workflow to place an item into a cart and go to the payment form), the blocks can be saved as a new component and can appear in the “Custom Components” list. The new components can be relatively simple or complex combinations of existing elements. Further, the new components can be published or otherwise made available for re-use by other users for building no-code applications.

In certain embodiments, the no-code platform provides a collection of pre-built elements and modules that users can customize and configure without manual coding or interacting with source code. Instead, no-code builders can modify characteristics of the pre-built elements to cause underlying source code to be modified without the user accessing the source code. The elements and modules can be visually arranged on the application design canvas (illustrated in FIG. 3) and can be combined to create specific actions and workflows. Further, custom components can be saved, published, and reused by other users, fostering collaboration and efficiency in application development.

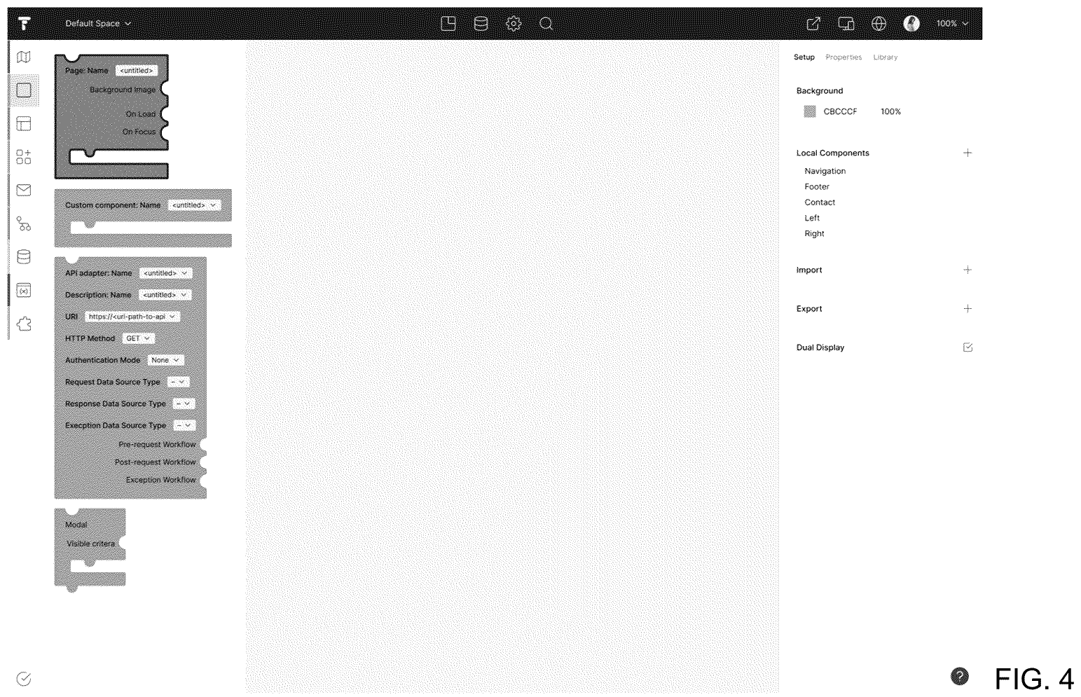

For instance, with reference to FIG. 4, when a no-code builder clicks on or otherwise selects “Container” from the component library, the user may be presented with a list of pre-built components that can be dragged and dropped on the application design canvas or otherwise selectable for use within a no-code application. The component library may be modified over time to include particular feature or characteristic values for elements in the component library based on usage by the no-code builders and/or end-users that interact with applications designed by the no-code builders. Further, the component library may be modified to include new elements or components. The characteristic values selected for elements and/or the new elements may be determined used a heuristic process or a machine-learning process that determines likely component selections based on training data. The training data may include actual usage data corresponding to usage of component elements by no-code builders and/or interactions by end-users with applications that include the component elements.

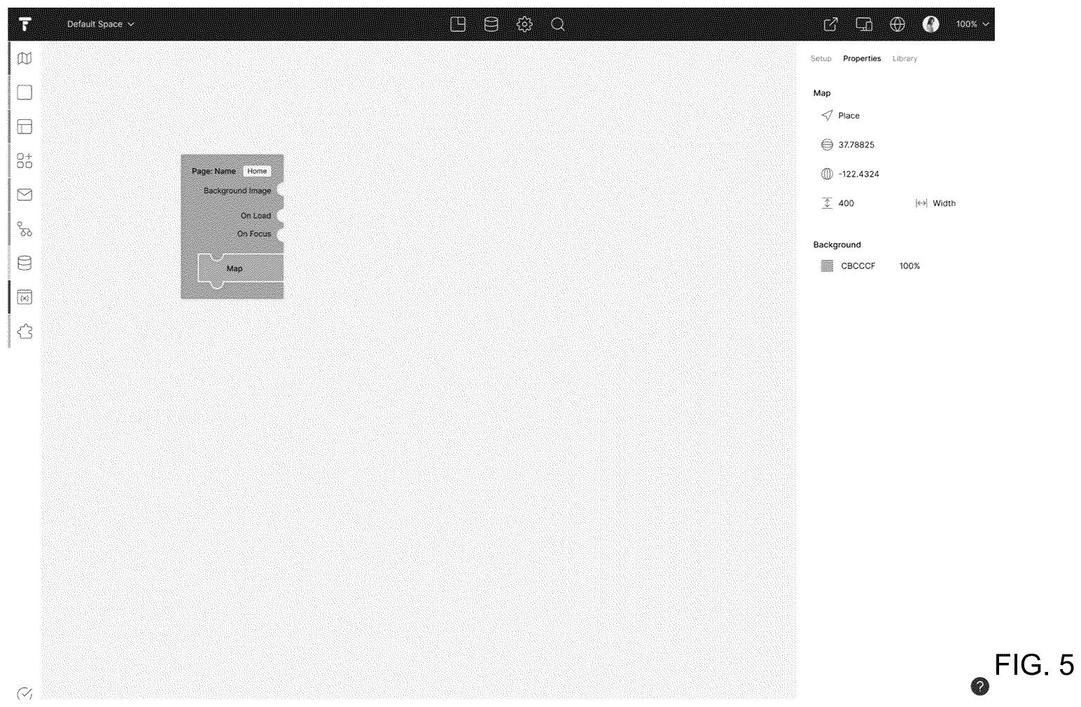

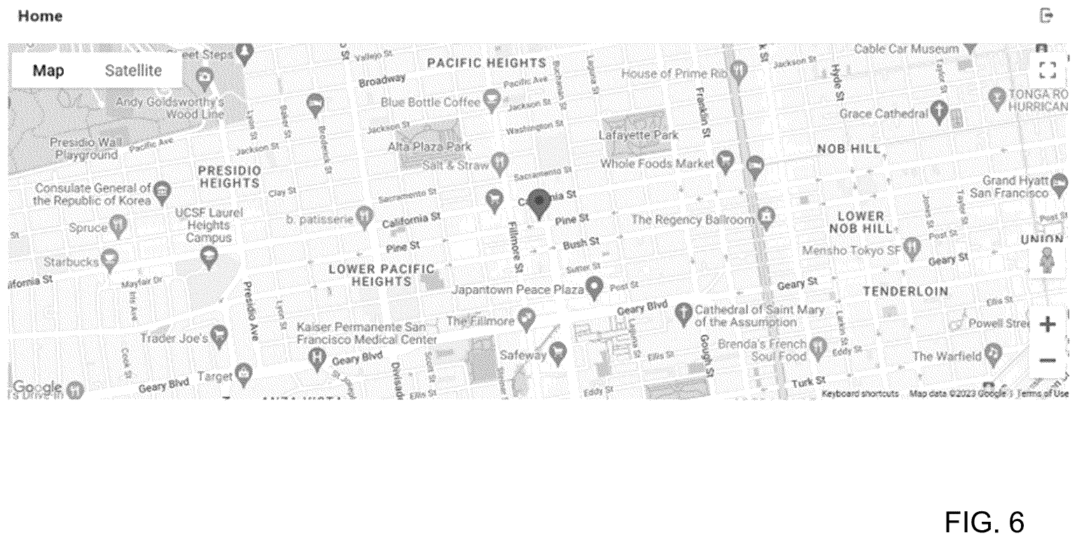

Selected components to be included as part of the no-code application are placed on the application design canvas illustrated in FIG. 3. When components are added to the application design canvas, the no-code builder can select a component from among those added to the application design canvas. The no-code builder can edit the properties of the selected component via, for example, the “Component properties” panel illustrated in FIG. 3. FIG. 5 illustrates an example of the component properties panel with example values for a map component. During build time of the no-code application, the component properties are applied to the element within the no-code application. FIG. 6 illustrates the output of the no-code map component element illustrated in FIG. 5 at runtime as part of the no-code application.

Returning to FIG. 5, it can be seen that the application design canvas can include one or more user interface elements to interact with the application design canvas. These user interface elements may be in addition to the selected components that may be added from the component library and interacted with on the application design canvas. For example, the user interface elements may include icons/functions to clean/clear the canvas (trash bin), or ‘+’ and ‘-’ to respectively zoom in or out. Additional non-limiting example interface elements can include search or selection interface elements for searching for or selecting components on the application design canvas (e.g., all components, components of a particular type, components including particular characteristics, etc.), add-to-library element for adding a component to the components library, change sheet or file element for accessing other design canvases that are part of the no-code application design space, and the like.

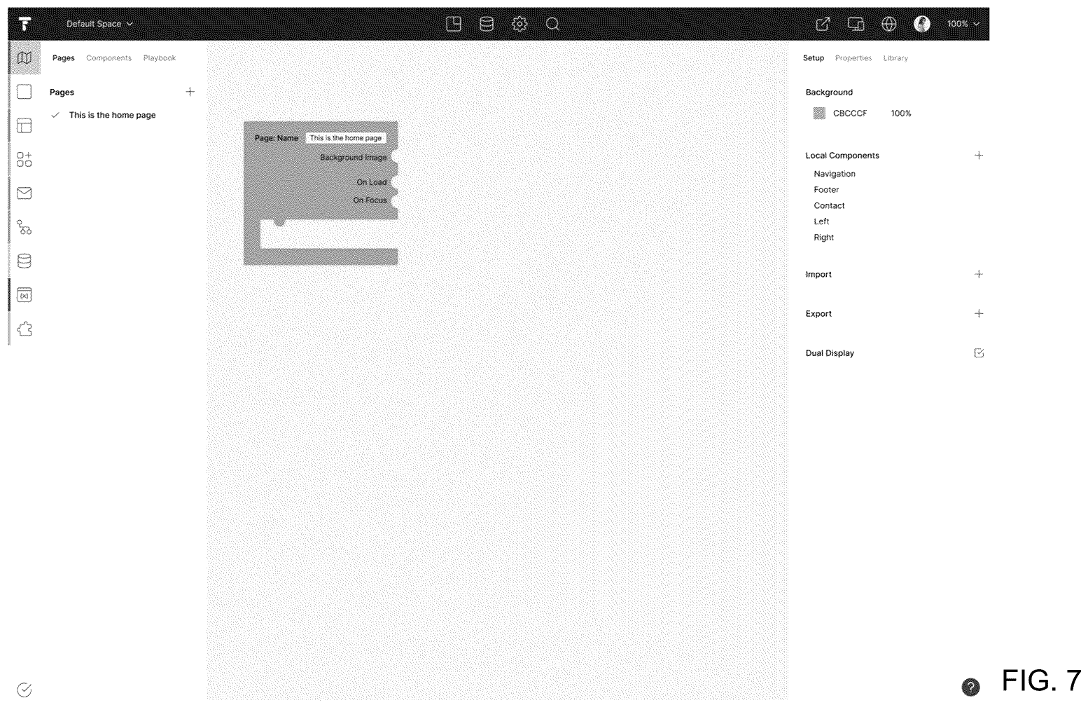

In some embodiments, the no-code application builder of FIG. 3 can include an “application navigator” pane. A more detailed example of the application navigator pane is illustrated in FIG. 7. The application navigator pane can include an overview of pages and components included in a no-code application designed by a no-code builder. A user (e.g., the no-code builder) can select a component from the application navigator to select or find the component within the application design canvas. It should be understood that the application design canvas may include multiple design canvas pages or sheets. For example, certain no-code application screens, features, or capabilities may be “programmed” using the no-code elements on a particular application design canvas sheet while other screens, features, or capabilities may be programmed on another application design canvas sheet.

The no-code development system may further include an intelligent adaptive system for modifying no-code components based on use by no-code builders and and/or interactions by users of no-code applications designed by the no-code builders. This adaptive system may be referred to as the application playbook and can be accessed via the adaptive user interface as illustrated in FIG. 1.

The application playbook can enable intelligent features, collaboration features, and the self-adapting and self-improving capabilities of the no-code development system. The application playbook may include features and aspects that operate differently at build-time and at run-time for the no-code application. To perform the adaptive operations, the application playbook may utilize one or more previous application building sessions (e.g., partial or full event transcripts), past interactions (e.g., one or more interaction events), and application context associated with execution of one or more previously developed no-code applications. Further, the adaptive operations may utilize build time data, intelligent filter systems, and runtime analytics systems.

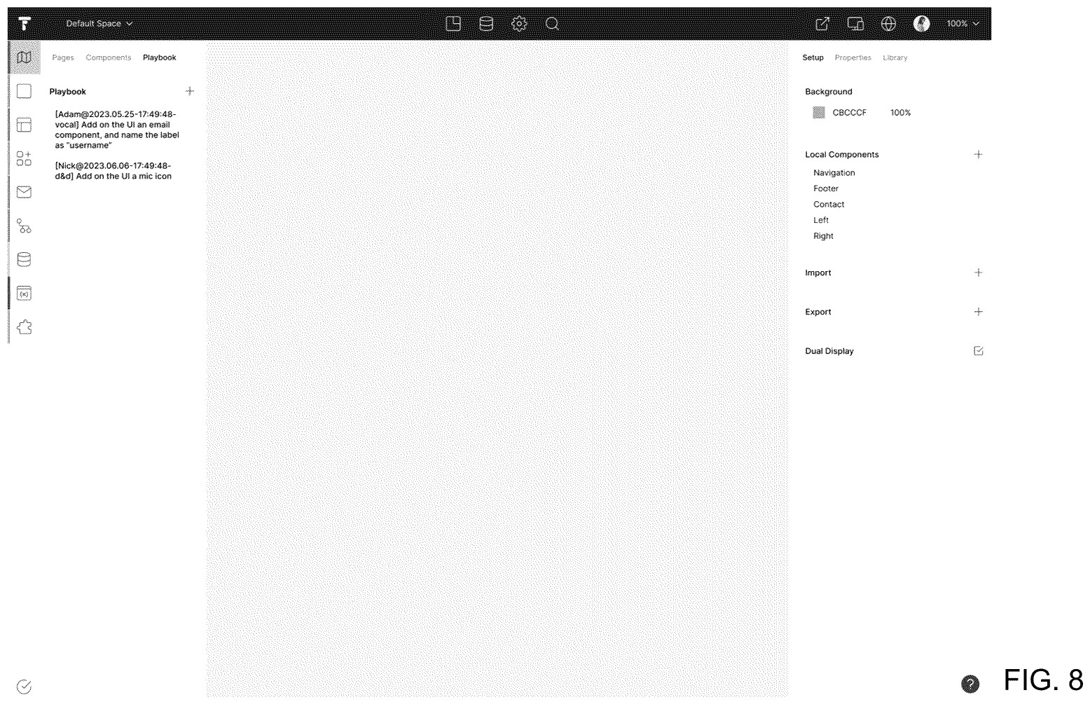

The application playbook may include entries associated with each past session corresponding to previous interactions with the no-code development system by a no-code builder. FIG. 8 illustrates a non-limiting example embodiment of past interactions logged by the application playbook. Using the example format “[user@timestampUTC-input_type] Command”, each event that occurs while building a no-code application can be added as a new entry in the application playbook. In some cases, events associated with deleted components may be removed from the application playbook. In other cases, the events associated deleted components may be maintained in the application playbook. In some such cases, an entry indicating deletion of a component may be inserted into the application playbook in response to a deletion event.

An example of an application playbook entry may be: [John@2023.06.07-15:41:23-vocal] Add onto the UI an email component, and change the label value to “User Account ID”. This example indicates that a user identified as John added an email component to a user interface and labeled the email component as User Account ID. Advantageously, by using the no-code development system, this email component that requests a user account ID is added to a user interface of an application being built without a user needing to understand how to code such a feature. FIG. 8 illustrates additional example application playbook entries associated with components added to the no-code application.

In some embodiments, every interaction with the application design canvas, such as adding a component, modifying a component, modifying a parameter of a component, and the like, may generate a new entry in the application playbook.

Over time, the continuous addition of entries to the application playbook will provide a series of details that will help the application playbook determine semantic relationships between components and provide a context baseline for components available via the component library. The semantic relationships may indicate how components within the component library are related to each other and/or to available compute resources or software resources or assets (e.g., images, models, animations, audio, font, etc.).

Further, as the application playbook may be alterable (e.g., by typing commands or correcting/modifying previous inputs), in some embodiments, the application playbook may be implemented as a virtual assistant or wizard that can present prompts to the no-code builder to ask questions designed to obtain context information for selected components added to the application design canvas, or to disambiguate between component options when a prediction confidence level is low, or when insufficient information is available to select or configure components using the machine learning features of the application playbook.

The no-code development system may include a recommendation system that can use the application playbook as training data for training a machine learning model. The recommendation system can use the trained machine learning model to suggest no-code components to a no-code builder that is building an application. Further, the recommendation system can use training data to train a machine learning model to pre-configure no-code components with default parameters that are most likely to satisfy design requirements for no-code builders. Advantageously, by pre-configuring the no-code components, application development can be further simplified enabling a greater number of users to develop applications, including unskilled users.

In certain embodiments, the no-code development system can be trained so that, based on certain context information, the no-code development system can suggest the next probable components to be added or configured on the application canvas to achieve a desired application purpose, to build an application feature, or that is semantically coherent with the “story” a user told. The story can refer to the objectives of the user or no-code builder in building the no-code application. This story may be described in a technical context or a layman's context (e.g., using plain or natural language) that describes the purpose of the application.

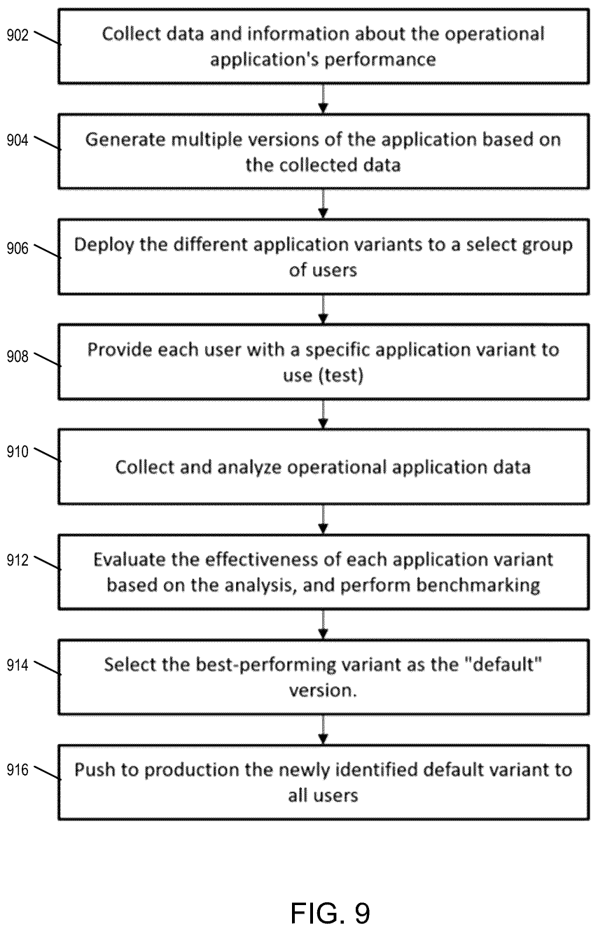

Using the context information and the no-code application as training data, the no-code development system can perform an interactive process to improve the machine learning algorithm and/or the prediction of probable components by future no-code builders. Moreover, the existing no-code application can be improved over time based on the training process as illustrated with the flowchart depicted in FIG. 9.

In certain embodiments, the no-code development system, with a sufficient level of context information to determine at least a purpose, a feature, or a use case for the application, can provide an overview or prediction of no-code components to complete a process. For example, if the no-code builder specifies that the purpose of the no-code application is to “put an item for sale” in the context of an e-commerce application, the no-code development system may determine or predict 7 steps or 7 no-code components are to be used to put an item for sale. Over time, and based on usage or user feedback, the no-code development system may learn that an optimization can be performed to combine or merge a couple of steps in the process to reduce the number of user interactions and/or user interface screens to complete the “putting an item for sale” task/process.

In another non-limiting example, a user may desire to build a rich web page full of multimedia content. The no-code development system may recognize or determine that the loading time of the web page at run-time is relatively high compared to similar web pages. As a consequence, the no-code development system may suggest that the no-code builder reduce the resolution of the less viewed or less interacted with pictures, videos, or multimedia items to reduce the amount of data to be loaded during each visit or during an initial visit to the webpage. Alternatively, or in addition, the no-code development system may suggest temporarily increasing the availability of hardware resources of the hosting system to support the conspicuous loading activity.

Referring to the no-code application improvement recommendation process of FIG. 9, regardless of the use-case, the process may begin at block 902. At block 902, the no-code development system collects performance data associated with execution and use of the no-code application by users. The collected data can relate to performance, user behavior, and any other metrics that can be used to determine an application configuration.

Based on the data and information collected at the block 902, the no-code development system creates a set one or more variants of the no-code application at the block 904. The variants may include different user interface layouts, no-code component configurations, or hardware configurations, and the like.

At block 906 and 908, the no-code development system can provide the different variants of the no-code application to different sets of users, or each user may be provided with a different variant of the no-code application. Alternatively, or in addition, different variants of the no-code application may be provided to the same users during different instances of execution. Providing the variants of the no-code application to different users may include executing different variants of the no-code application in response to a user request to access the no-code application (e.g., by accessing a server hosting the no-code application or a web-page that is included as part of the no-code applications user interface).

At block 910, the no-code development system collects and analyzes performance data associated with execution of the variants of the no-code application. The performance data may include data associated with the execution of the no-code application including, for example, latency, retention data, target (e.g., sales) conversions, length of time to complete a task, number of user interactions to complete a task, and the like. Moreover, the collected data may include test data and user feedback data that can be used to evaluate the effectiveness of each variant of the no-code application. The collected data may include any type of data that can be used to infer a decision on which application variant is the most effective or desired in terms of performance, user experience, and other evaluative factors.

At block 912, the no-code development system evaluates the effectiveness of each application variant based at least in part on the analysis of the performance data collected the at block 910. In some embodiments, evaluating the effectiveness of each application variant may include performing benchmarking of the application variants based on the collected performance data. In some embodiments, the effectiveness of each variant may be determined based at least in part on user feedback, such as user ratings. Further, in some cases, the effectiveness of each application variant may be determined based at least in part on the context of the application. For example, in some cases, the longer the average user spends interacting with the application (e.g., a video game or a shopping site) the better the effectiveness of the application variant. In other cases, the less time the average user spends interacting with the application, the more effective (e.g., such as with an application associated with applying to a service or program). In other cases, it may be desirable for the average user to spend more average time interacting with portions of the application and less average time interacting with other portions of the application. For example, an application variant that results in the average user browsing an online store longer, but less time completing a transaction may be more desirable than other configurations of the application.

At block 914, the no-code development system can select the best performing variant as the default version of the application presented to users. The best performing variant may vary based on the metrics applied. The metrics applied or selected may be determined based on the type of application.

At the block 916, the best performing variant may be recommended or automatically supplied to users by the recommendation system illustrated in FIG. 1 of the no-code development system.

Past interactions with the no-code development system can serve as training data for the machine learning algorithms employed by the no-code development system. As stated above, the past interactions can include the application playbook entries reflective of user interactions (typically from no-code builders) with the application canvas as illustrated in FIG. 8. Further, past interactions can include user interactions with a no-code application that is in use or under test. These user interactions may be by no-code builders or end-users of the application.

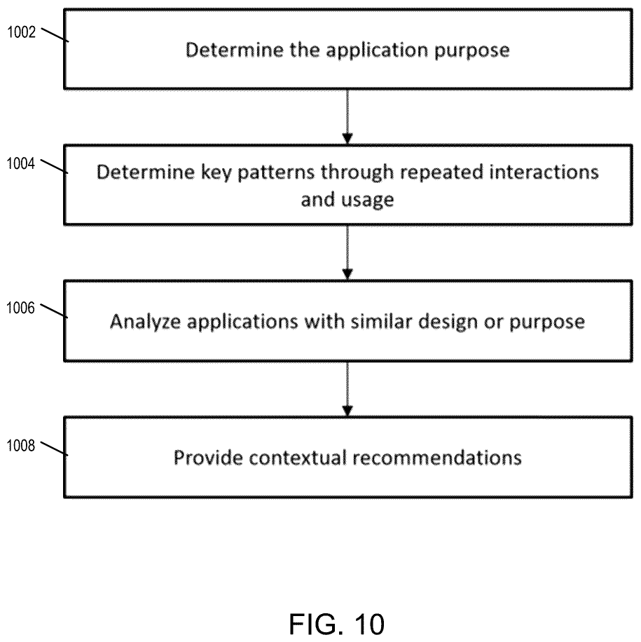

In some embodiments, the past interactions can serve as training data for a machine learning algorithm that recommends no-code components for a no-code builder building a no-code application. The recommended no-code components may be recommended or selected based on a context of the no-code application being generated. The context may include the purpose of the no-code application and/or the no-code builder's goals for the application. By understanding user goals, recognizing patterns, and drawing insights from similar applications, the no-code development system can provide coherent suggestions for components and/or the configuration of components. These suggestions can help streamline the application building process. FIG. 10 presents a flowchart of an example embodiment of generating no-code component recommendations based on context.

The process may begin at block 1002 where the no-code development system determines a purpose of the no-code application. The purpose may be determined at the start of the development process or at some time during the development process. The purpose of the no-code application may be determined by querying the no-code builder or in response to input by the no-code builder with a user interface. For example, the no-code builder can interact with a setup wizard that asks a series of questions to determine a desired type of no-code application. For instance, the setup wizard may ask whether the no-code application is being created to sell physical items, sell services, sell digital content, present text information to a user, present multimedia content to a user, host interactive content, etc.

Alternatively, or in addition, the no-code development system may determine a goal or purpose of the application by comparing the no-code application to previously created applications. This comparison process may occur once or multiple times throughout the development process. Further, the comparison process may include comparing selected no-code components, configurations for the selected no-code components, and/or the context within which the no-code components are used during creation of the no-code application with corresponding information for other no-code applications created using the no-code development system.

At block 1004, the no-code development system may analyze historical data associated with creation of no-code applications to identify patters in no-code builder behavior. For example, if a no-code builder adds a component that allows file loading, the no-code development system may recognize that typically components associated with adding “button” components are added shortly thereafter. Thus, when a new application is being developed, and the no-code development system detects that the no-code builder is adding a file loading component, the no-code development system may recognize the build pattern and may suggest as the next set of probable components a “button” component that would trigger the upload of the file to a specific location. In addition to suggesting the next component, the no-code development system can provide contextual recommendations, e.g., it may suggest editing the label value of the button to “Upload,” based on observed patterns and common practices from other no-code applications developed by other users.

At block 1006, the no-code development system can further analyze applications with similar design or purpose. By using the purpose identified at the block 1002, the no-code development system can access other no-code applications that may be designed by other users and that are determined to be associated with a similar purpose. By analyzing applications with similar design or purpose, the no-code development system can make inferences and suggest design decisions. For example, the no-code development system can compare similar no-code applications to suggest or infer that it is preferable to position a file upload button relative to the file picker on the right side rather than below the file upload component to maintain consistency and improve usability.

At block 1008, the no-code development system provides contextual recommendations to the no-code builder. Providing the contextual recommendations to the no-code builder may include outputting one or more recommendations identified at the blocks 1004 and/or 1006 based on a comparison of the purpose of the no-code application with other no-code applications created by the no-code builder or other no-code builders. Alternatively, or in addition, providing the contextual recommendations to the no-code builder may include outputting one or more recommendations identified at the blocks 1004 and/or 1006 based on a comparison of the design or components selected for the no-code application with the design or components used in other no-code applications created by the no-code builder or other no-code builders.

In some embodiments, the no-code development system can recommend particular no-code components for a no-code application based on input or feedback from the no-code builder. The input may include a description (e.g., typed, vocal, or otherwise) of a desired feature. In some such cases, the no-code development system can query the user (e.g., using a set of questions or a component selection wizard) until sufficient context is collected to identify a recommended no-code component (e.g., a text box, a map, a file upload function, a multimedia output component, a feature loop, etc.). Based on the provided information or content, the no-code development system can propose one or more options to achieve or help achieve the no-code builder's objective as determined based on the provide information. In some embodiments, based on the selected option, the no-code development system can suggest a set of components to be used to implement the chosen path to realize the desired feature. Moreover, based on selected components, the no-code development system may recommend addition components to achieve the no-code builder's desired feature or other features that are predicted to be desired based on the already determined features.

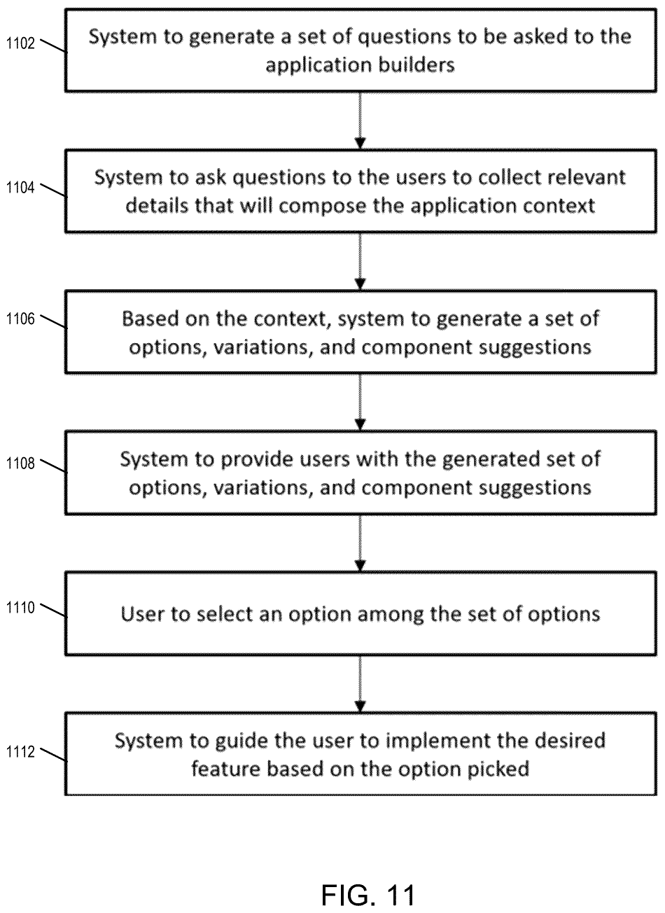

FIG. 11 presents a flowchart of one non-limiting example of a no-code component recommendation process that uses user input to identify no-code components to recommend. At block 1102, the no-code development system generates or identifies a set of questions to query the no-code builder. In some embodiments, at least some of the questions generated may be determined based at least in part on earlier responses, earlier selected no-code components, the context of the no-code application, or any other factor that may be used to determine a question to present to a user.

At block 1104, the no-code development system presents the set of questions identified at the block 1102 to the no-code builder. By asking the questions at the block 1104, the no-code development system can determine a context of the feature the no-code builder desires to add to the application. In other words, the questions may be used to determine the no-code builder's requirements or intent for the no-code application.

At block 1106, based on the context information obtained at the block 1104, the no-code development system identifies a set of component options or configurations for one or more components. At the block 1108, the no-code development system can present the set of component options or configurations for one or more components to the no-code builder. The options (e.g., components or configurations for a component) presented to the no-code builder may represent different options for achieving or implementing a particular feature. Differences in the different options may relate to trade-offs in different metrics (e.g., memory use, speed, useability, etc.) or to personal design preferences.

At block 1110, the no-code development system may receive a selection from the no-code developer of an option from the set of options presented at the block 1108. In some cases, the no-code developer may select none of the options. Instead, the no-code builder may elect not to include the feature or may elect to implement the feature using an alternative design not included in the recommendations. In some cases, the no-code development system may update the machine learning algorithm used to infer potential component selection or configuration options based on the user's selection at the block 1110. In other words, the no-code builder's selection may be used as additional training data.

At block 1112, the no-code development system may guide the no-code builder to implement a desired feature as identified at the block 1102 or the block 1104 using the selection received at the block 1110. In some cases, the no-code development system may recommend particular configurations for a selected no-code component or may recommend complementary components to add to the selected no-code component to complete implementation of the desired feature.

Advantageously, the recommendation capabilities of the no-code development system enable less technical users to build no-code applications. Less experienced or more creative users may tell a story and be less precise on possible implementation of functionalities. The no-code development system can ask for clarifications or further details to complete a picture of the context or purpose of the application. The no-code development system using, for example, the process of FIG. 11 can divide the application into different application features (e.g., by decomposing the overall application into screens and functionalities, and proposing different implementation options). Upon a no-code builder selecting a component, a feature, or a recommendation, the no-code development system may suggest one or more components and their optimal configuration based on the level of training/learning to date. The process may continue until the application is completed or deployed.

In other words, by engaging in a dialogue, seeking clarifications, decomposing the user's vision, and providing guided component suggestions, the no-code development system assists less technically experienced users to develop a software application without needing an understanding of software coding. In generating the no-code application, the process may be iterative enabling the no-code builder to gradually build an application while receiving support and recommendations from the no-code development system.

Advantageously, embodiments disclosed herein enable a user (e.g., a no-code builder) to express application ideas as a narrative (e.g., in the form of a story) while providing less precise details about the implementation of specific functionalities of the application. In some such cases, the no-code development system can query the user to obtain additional clarifications and details to complete the understanding of the desired features of the application and the context in which the application is to be used.

Once the no-code development system has determined application context, it can divide the application into smaller components corresponding to portions, features, or functionalities of the application. The no-code development system can then use the recommendation processes (e.g., the process of FIG. 11) to recommend different components to implement the smaller components or sub-portions of the application. Thus, based on the decomposition of the application as a whole, the no-code development system can propose different implementation options to the user for each sub-portion of the application.

Upon a user (e.g., a no-code builder) selecting an implementation option for the application or a sub-portion of the application, the no-code development system can act as a sort of “wizard” and can suggest components needed to implement the selected option.

The development process can be an iterative process. In other words, throughout the building process, the no-code development system can continue to suggest components and configurations, guiding the user until the application is completed or ready to be deployed. Further, the selection or identification of suggested components to present to the user may be influenced based on earlier selections by the user of components.

As illustrated in FIG. 2, the no-code development system can include a prediction engine. The prediction engine may be responsible for collecting all relevant information and to determine a sort of “shortlist of the best next component” to recommend from the components library. The prediction engine may work in conjunction with the recommendation engine, which may use the prediction engine to generate recommendations.

The recommendation system, starting from the “shortlist of the best next component” and based at least in part on the application variants benchmarking and analysis, can suggest the best possible configuration for the application variant/component option the user picks among the component options. Initially, the system may suggest default values for no-code components. For example, default location values for component placement, default colors, default sizes, default acceptable user inputs, etc. Over time, the no-code development system can learn what are the best/optimal/more efficient configurations of the no-code components. Further, the no-code development system can use a similar process to determine the optimal hardware components and configuration of hardware components (e.g., graphics cards, system memory, input devices, etc.) for computing systems that execute the no-code application. As the no-code development system determines preferred recommended configurations of the software/hardware, the no-code development system can suggest the optimal component/application configuration for the no-code builder's application purpose.

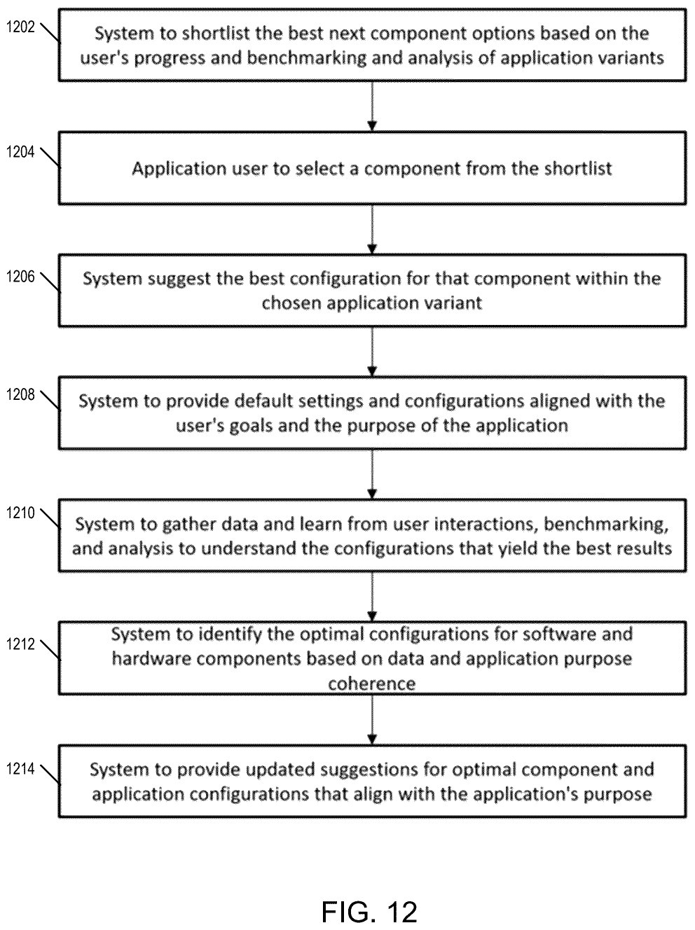

FIG. 12 presents a flowchart of one non-limiting example of recommending no-code component configurations based at least in part on implemented no-code application components. As previously described, the recommendations may optimize over time as training data is obtained through usage of the no-code development system over time.

The process illustrated in FIG. 12 may begin at block 1202 where the no-code development system can identify a subset of no-code components to recommend to a no-code developer based at least in part on progress in developing the no-code application. In other words, the recommended no-code components may be recommended based at least in part on portions of the no-code application that has already been created on the application canvas, or the no-code builder's current progress in creating the no-code application. Further, the subset of no-code components may be selected or shortlisted based at least in part on benchmarking or analysis of application variants for the no-code application or other no-code applications analyzed for training purposes. The identified subset of no-code components recommended to the no-code builder may be presented to the no-code builder via a user interface of the no-code development system.

At block 1204, the no-code development system receives an indication of a no-code component selected from the shortlisted set of no-code components identified at the block 1202. At block 1206, the no-code development system suggests a recommended configuration for the selected no-code component. The configuration can include any type of parameters or metrics associated with the no-code component. It should be understood that the type of parameters or metrics may vary based on the type of component. For example, a user interface component may have parameters associated with location, color, size, access controls, etc. As another example, a component relating to data sorting may have parameters associated with storage of the data, the type of sorting, the timing of sorting, etc. The recommended configuration may be determined using a machine learning algorithm trained using historical data associated with previously developed no-code applications. In some cases, the recommended configuration for the no-code component may be based at least in part on the purpose of the no-code application being developed.

Optionally, at block 1208, if insufficient training data exists for determining a recommended configuration for a particular selected no-code component, the block 1206 may be omitted and the no-code development system may recommend default settings or configurations for the no-code component. In some cases, the default configurations may vary based on the identified purpose of the no-code application being developed.

At block 1210, the no-code development system can determine the no-code component configuration or configurations that yield the best results for a no-code component. The determination may be made based on user interaction data with the no-code component or the no-code application that includes the no-code component, benchmark data, resource utilization data, or any other data that may be used to learn the optimal configuration for a no-code component that yields the best performance for a component or application. The determination of the optimal, preferred, or desired no-code component configuration may be based on various factors such as performance, user experience, and the specific purpose of the application. The determination of the optimal, preferred, or desired no-code component configuration may be determined using a learning process that uses past configuration data and improvements in the various factors (e.g., performance or user experience) over time.

At block 1212, the no-code development system may determine the optimal configurations for the no-code component based on the data gathered as part of the operations of the block 1210. Further, the no-code development system may base the determination of the optimal no-code component configuration based on a context or purpose of the application. Thus, at block 1214, the no-code component system may provide suggestions of no-code component configurations that align with the application's purpose. Moreover, determining the no-code component configuration may include determining that the suggested configuration aligns with the intended functionality, performance requirements, and other relevant considerations of the application or no-code component. In some embodiments, the process illustrated in FIG. 12 may be used to determine a suggested configuration of hardware used to host the no-code application.

As described above, the no-code builders may be used that use the no-code development system to create an application. End-users or application users may be the intended targets or customer users of the application. These application users may not have access to the no-code development system. However, in some cases, user interaction data associated with interaction by the application users with the application may be provided to the no-code development system to help improve the recommendations of the no-code development system to the no-code builders during creation of no-code applications.

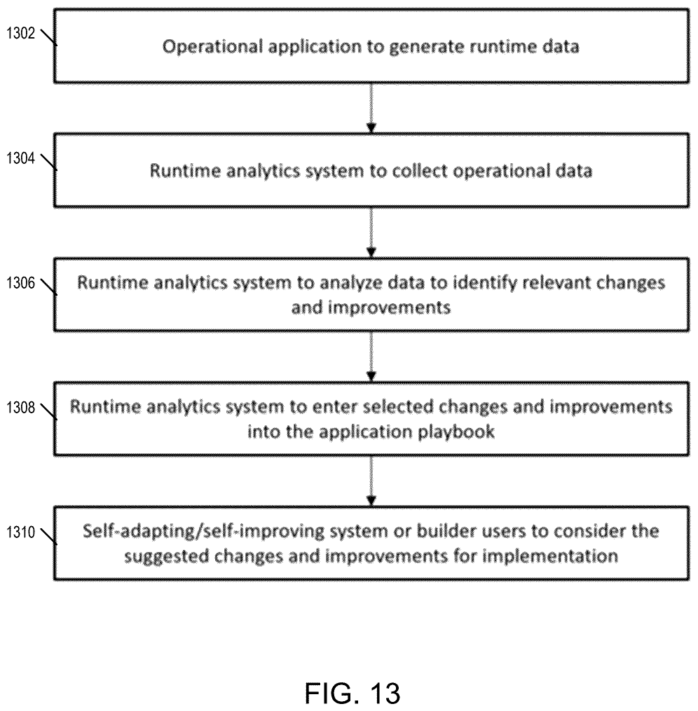

FIG. 13 presents a flowchart of one non-limiting example use-case of using application user data to improve an application. At block 1302, the application may generate runtime data. This runtime data may include user interaction data associated with an end-users interaction with the application. Further, the runtime data may include data generated by the application in response to operations performed by the application and/or interactions by the user with the application. The application may be streamed or executed at a host computing system. Further, the application may be one of a set of variants of the application that are being tested to determine the optimal or preferred variant.

At block 1304, a runtime analytics system may access the runtime data generated at the block 1302. The runtime analytics system may, at least in part, be integrated with the application. Alternatively, or in addition, the runtime analytics system may be hosted by a computing system that hosts the application. In some embodiments, the runtime analytics system may be hosted on a separate computing system from the application, but can communicate with the host computing system of the application to obtain the runtime data. In some embodiments, the runtime analytics system is part of the no-code development system. In other embodiments, the runtime analytics system is a separate system that can communicate with the no-code development system or that can train or modify one or more machine learning algorithms used by the no-code development system for recommending no-code components to a no-code builder.

At block 1306, the runtime analytics system analyzes the runtime data to identify recommended changes or improvements to the no-code application. The recommended improvements can be determined by applying the runtime data to a machine learning algorithm. In some cases, the runtime data may be collected from a plurality of instances of the application. At least some of the plurality of instances of the application may differ from at least some other instance of the application. In other words, the plurality of instance of the application may include variations of the application. The no-code builder

At block 1308, the runtime analytics system can enter recommended modifications to the application into the application playbook. At block 1310, the no-code development system or the no-code builder can determine whether to implement one or more of the suggested application changes.

By collecting operational data, considering the application context, incorporating insights from prior improvements, analyzing application variants and testing, and maintaining an application playbook, the runtime analytics system can ensure that it can make informed decisions regarding changes and improvements to the application. The improvement to the application can help enhance the overall performance and user experience of the application. Further, the identified settings changes and improvements/suggestions can be shared/entered in the application playbook enabling them to be applied to training of the machine learning based recommendation processes described herein as well as to be used by no-code builders building future applications.

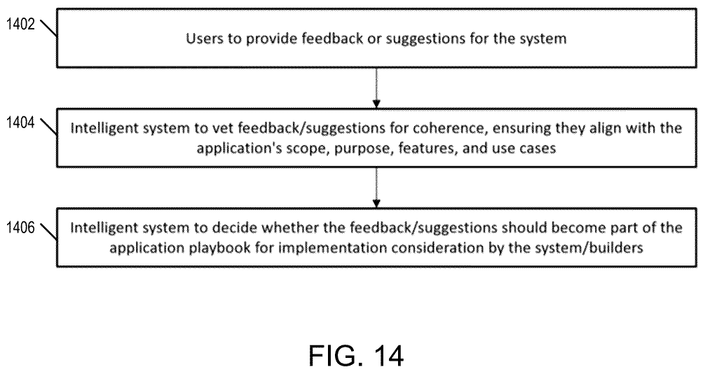

End-users or application users typically cannot directly modify an application. However, end-users can provide feedback relating to use of an application. In some embodiments, the feedback of the end-users can become part of the application playbook events for implementation consideration by the no-code development system or no-code builders. FIG. 14 illustrates a flowchart of a non-limiting example process of incorporating user feedback into the application playbook.

At block 1402, the no-code development system receives user feedback or suggestions from a user (e.g., an end-user) of an application. The feedback may be received from a feedback collector hosted by a component system that hosts the no-code application or is in communication with the computing system that hosts the no-code application. The feedback collector can supply the user feedback to the no-code development system.

At block 1404, the feedback is vetted for coherence by an “intelligent filter” system which ensures that suggestions, feedback, or new ideas, make sense within the context of the application's scope, purpose, features, and use cases. Thus, only coherent feedback is admitted into the application playbook. For example, suppose that the no-code application is an online marketplace. In such a case, feedback that relates to the useability of the online marketplace, the responsiveness of the application, the ease of search of products available through the application, bugs or coding errors in the application, etcetera may be relevant feedback that may be included for consideration by the no-code developer. However, feedback that relates to the quality of the purchased product, the packaging, the delivery, etcetera may, may not be relevant feedback with respect to the useability, design, or efficiency of the no-code application itself regardless of its potential relevance to the company as a whole. Thus, such feedback may be excluded from the no-code development system for consideration by the no-code developer.

The feedback collector can be implemented as a virtual assistant embedded in the application (e.g., similar to chatbots on websites). The feedback collector enables users to submit feedback, report bugs, suggest additional features, and the like. The feedback may be shared directly with the no-code builders through the application playbook. Moreover, the no-code development system or the feedback collector can evaluate and rank the feedback based on attributes of the feedback, such as quantity, urgency, coherence, and the like. At block 1406, based on the evaluation of the feedback, the feedback collector or the no-code development system can determine whether to supply the feedback to the no-code builder or include it as part of the application playbook, or to discard it.

In some embodiments, feedback from the application users is weighed differently compared to feedback from the no-code builder. Further, for bug reporting, it is expected that multiple users will/may report the same or similar issue within a limited period of time that will naturally and organically form “clusters” of similar requests that can be understood and fixed by the no-code development system itself without human intervention. For example, if multiple users report a misspelling or typo of the word ‘name’ as ‘nmae,’ the system, through the intelligent filter, can recognize it as a coherent bug and address it accordingly.

In some cases, the determination of whether to fix the bug may be based on whether it aligns with the application's purpose and scope. In other words, what some users may identify as a bug may be an intentional design choice and not a bug. For example, if a user magnifies an image of a first product and the magnification is maintained when viewing an image of a second product, some users may identify the failure to reset the magnification as a bug in the application. However, the failure to reset magnification may be an intentional design choice to help assist shoppers with diminished vision and may be within the scope of the application's purpose. Nevertheless, if several users identify the magnification issue as a bug, it may be presented to the no-code builder to consider whether to modify the design choice.

Additional details and embodiments of the no-code development system, including the machine learning models trained and used by the no-code development system, can be found in Appendix A of U.S. Provisional Application No. 63/594,851, which is hereby incorporated by reference in its entirety and made a part of the present disclosure. Further, Appendix A describes additional examples relating to the use of the no-code development system for developing an application and for improving applications designed by no-code builders.

### Example Interactive Computing Environment

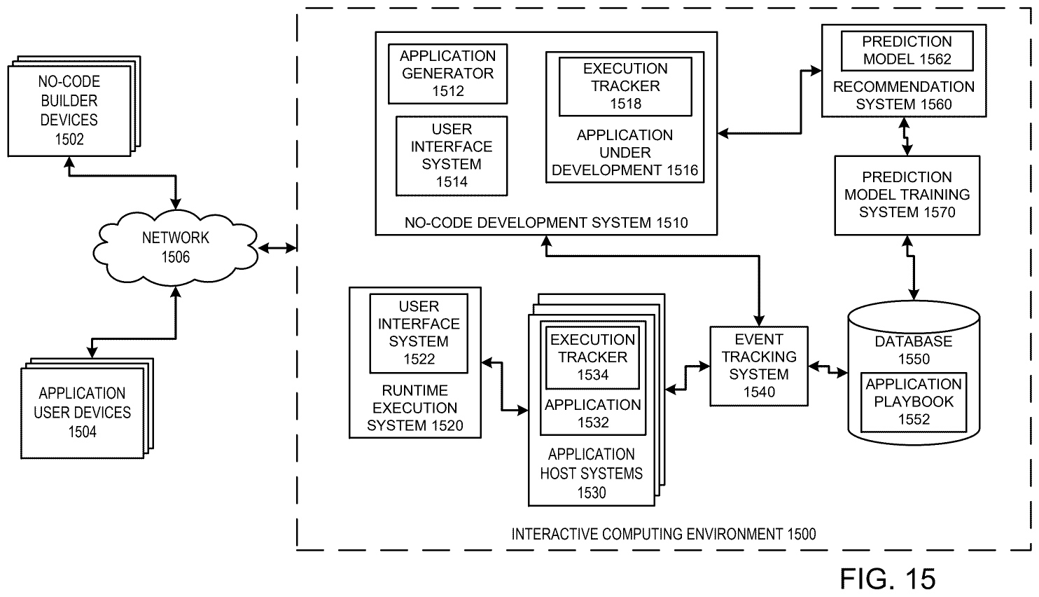

FIG. 15 illustrates an interactive computing environment 1500 in accordance with certain embodiments. The interactive computing environment 1500 may be implemented in a networked computing environment. For example, the interactive computing environment 1500 may be implemented at a data center or within a cloud computing environment. Moreover, the interactive computing environment 1500 may include a plurality of homogenous or heterogenous computing systems that may be located within a single physical location or may be distributed across multiple physical locations.

The interactive computing environment 1500 may include a no-code development system 1510. In some cases, the interactive computing environment 1500 is a no-code development system 1510, and the no-code development system 1510 may include the systems of the interactive computing environment 1500 described herein. The no-code development system 1510 enables users to develop or build applications using no-code components. Users may access the no-code development system 1510, using no-code builder devices 1502, over a network 1506. The no-code components may include building blocks that can be used to build an application without seeing or understanding software code. Users who build applications without using code may be referred to as no-code builders. The no-code builders may access a user interface generated by a user interface system 1514 of the no-code development system 1510 to select and place no-code components within a no-code application under development. For example, the no-code builder may drag a graphical representation of a no-code component onto an application canvas.

The no-code development system 1510 may include a user interface system 1514. The user interface system 1514 may include any type of user interface that enables a user to interact with the no-code development system 1510 via a no-code builder device 1502. For example, the user interface system 1514 may include a graphical user interface, a text-based interface, an interactive voice response (IVR) interface, a voice user interface (VUI), or any other type of user interface that enables a user to select a no-code component and position it within an application canvas, or other workspace, where an application under development 1516 is being created or developed.

The no-code development system 1510 may include an execution tracker 1518 within the application under development 1516 or the resultant application of the application under development 1516. The execution tracker 1518 may be used to track usage statistics relating to user interactions with the application that results from the application under development 1516. The usage statistics may be used to determine improvements to the application using, the recommendation system 1560 and/or to train a prediction model 1562 using the prediction model training system 1570.

The application generator 1512 may generate an application from the application under development 1516. The application generator 1512 may generate different versions of the application to execute on different types of computing systems. For example, the application generator 1512 may generate a version of the application, corresponding to the application under development 1516, to execute on a computing system executing a Windows® operating system, on a computing system executing a MacOS®, or on any other type of laptop or desktop computing system. Further, the application generator 1512 may generate a version of the application, corresponding to the application under development 1516, to execute on a mobile device (e.g., a smartphone), a gaming device, or any other type of computing system.

Further, the application generator 1512 can generate different versions of an application. The different versions of the application may be used by the recommendation system 1560 to recommend modifications to the application under development 1516 based at least in part on usage statistics associated with the different version of the application. The different versions of the application may include any type of distinction that is selected to test or determine whether changes can improve satisfying a particular goal for the application, such as execution speed, customer retention, customer conversions, memory reduction, user satisfaction, and the like. For example, one version of an application may position user interface elements at the top of a window while another version of the application may position at least some user interface elements along the left side of a window. As another example, one version of an application may use a carousel to display options while another version of an application may display options in an ordered list displayed in a column format. Based on usage statistics obtained using the execution tracker 1518, the recommendation system 1560 may make a recommendation of a preferred application version, which may be one of the versions under test, a different version, or a blend of multiple versions.

The recommendation system 1560 may execute a prediction model 1562 to generate a recommendation of a no-code component to include in the application under development 1516. Alternatively, or in addition, the prediction model 1562 may generate a recommendation of a configuration of a no-code component. Determining a recommended configuration of the no-code component may include determining a value of one or more parameters of the no-code component. The one or more parameters of the no-code component may vary depending on the type of no-code component and may include any type of parameter that may be specified by a no-code builder. These parameters may relate to a look and feel of the no-code component, the placement of the no-code component, a value of a control variable of the no-code component, a value of a data variable of the no-code component, or any other type of parameter that may be associated with a no-code component. For example, the one or more parameters may relate to a location of the no-code component within a user interface, a color of the no-code component, a shape of the no-code component, a number of iterations of an action or event associated with the no-code component, a timing of actions associated with the no-code component, a condition associated with execution of the no-code component, and the like.

The prediction model 1562 may include any type of prediction model that can determine a recommendation of a no-code component or a no-code component configuration based at least in part on input data. This input data may include one or more of a no-code application under development 1516, usage data corresponding to usage of an application, an objective or goal of the application, or any combination of the aforementioned. Further, the input data may include the application playbook 1552. The application playbook 1552 may include a log of events relating to the creation of the application under development 1516. Each interaction with the no-code development system 1510 by a user may be recorded and include in the application playbook 1552. For example, the application playbook 1552 may include the selection of a no-code component, the configuration of a no-code component, the placement of the no-code component within an application canvas, the removal of a no-code component, and the like. Further, in some cases, the application playbook 1552 may include usage data associated with a user's (e.g., an end-user's or customer's) interaction with an instance of the application, such as an instance of the application hosted by an application host system 1530 and accessible by an application user device 1504. The application playbook 1552 may be stored at a repository or database 1550 accessible by the no-code development system 1510, the prediction model training system 1570, and/or an event tracking system 1540.

The prediction model 1562 can be generated using any type of machine learning process that is capable of predicting or suggesting a no-code component or no-code component configuration. For example, the prediction model 1562 may include or be implemented using a support vector machine model, a random forest algorithm or classification, a deep neural network, a regression algorithm, or a clustering algorithm, among others. Moreover, in some embodiments, the prediction model 1562 may include a plurality of machine learning models, which may each be of the same type or of a different type. In cases where the prediction model 1562 includes a plurality of machine learning models, the outputs of the machine learning models may be combined using weighted voting, averaging, or any other type of consensus strategy that may be used to produce a single prediction from the outputs of a plurality of machine learning models.

The prediction model 1562 may be generated or trained by the prediction model training system 1570. The prediction model training system 1570 may use previously generated no-code applications generated using the no-code development system 1510 as training data. The previously generated no-code applications may include purpose-built applications built for training purposes and/or previously developed applications by users of the no-code development system 1510. Further, the prediction model training system 1570 may continue to train the prediction model 1562 over time as additional no-code applications are developed by users or customers of the no-code development system 1510. In some cases, usage data of end-users may be provided as training data to the prediction model training system 1570.

Usage data of users interacting with published applications generated by the no-code development system 1510 may be captured by the execution tracker 1518 included in the published applications (e.g., application 1532). Further, the captured data may be provided to the event tracking system 1540, which can aggregate usage data and store it at the database 1550. Further, the event tracking system 1540 can aggregate usage data for different versions of the application (e.g., different versions of the application 1532). The usage data may be included in the application playbook 1552 or may be stored separately. The captured usage data may be used by the prediction model training system 1570 to help train the prediction model 1562. Further, the usage data may be used by the prediction model 1562 to help determine modifications to the application. These recommended modifications may be based on a desired goal or objective for the application, such as to improve user retention, user conversion, user satisfaction, and the like. Further, usage data may be used to determine modifications to the application that may improve application performance. For example, if the usage data indicates a particular set of features that are accessed together or within a threshold period of time, modifications may be made to the application to improve resource allocation relating to the set of features.

The event tracking system 1540 can include any system that can track interactions with the no-code development system 1510, the application under development 1516, and/or the application 1532. The event tracking system 1540 may be a computing system or may be a tracking application hosted by a computing system. The event tracking system 1540 may track interactions with the no-code development system 1510 relating to creating a no-code application (e.g., the application under development 1516). In some cases, the event tracking system 1540 tracks interactions relating to creating the application under development 1516. In other cases, the event tracking system 1540 tracks any interaction with the no-code development system 1510. For example, the event tracking system 1540 may track the selection of no-code components, the placement of no-code components, the removal of no-code components, the configuration of no-code components, or any other action that may be performed by, for example, interacting with the user interface system 1514 to generate the application under development 1516. The event tracking system 1540 may provide these tracked events to the application playbook 1552.

Further, the event tracking system 1540 may track interactions with a published application (e.g., the application 1532) that is accessible by end-users. The event tracking system 1540 may track each user interaction with the application 1532 via an execution tracker 1534 included in the application 1532 by the no-code development system 1510 during development of the application 1532. The execution tracker 1534, like the execution tracker 1518, may include any system that can track user interactions with the application 1532. For example, the execution tracker 1534 may include a cookie that tracks user interactions with the application 1532.

Applications that have been generated by the no-code development system 1510 may be hosted by one or more application host systems 1530. For example, the application host system 1530 may host the application 1532, which may be a version of the application under development 1516. Although a single application is illustrated, it should be understood that one or more of the application host systems 1530 may host one or a plurality of applications, which may be different versions of the application 1532 and/or may include different unrelated applications.

The interactive computing environment 1500 may further include a runtime execution system 1520. The runtime execution system 1520 enables users to execute or to access no-code applications (e.g., the application 1532), or applications built using no-code components. No-code applications may include software code that corresponds to the no-code components used to create the no-code applications, but the software code may be hidden from the users. Users may access the runtime execution system 1520, using application user devices 1504, over the network 1506. The applications created using the no-code development system 1510 may be hosted by one or more application host systems 1530. The runtime execution system 1520 may provide an application user device 1504 with access to a no-code application hosted by an application host system 1530. Users may access or interact with the application 1532 through a user interface system 1522. The user interface system 1522 may include any type of user interface that enables a user to interact with an application hosted by an application host system 1530. For example, the user interface system 1522 may be a graphical user interface. In some cases, the application host system 1530 may include or may execute the runtime execution system 1520. In other cases, the runtime execution system 1520 may be a separate computing system that regulates access to the application host system 1530 and/or the application 1532 hosted by the application host system 1530.

Although various elements of the interactive computing environment 1500 are illustrated separately, in certain embodiments, elements of the interactive computing environment 1500 may be combined or executed by more or fewer computing systems. For example, the recommendation system 1560 may be implemented by the no-code development system 1510. As another example, the prediction model training system 1570 may be implemented by the recommendation system 1560.

The no-code builder devices 1502 may include any type of computing system that can communicate with the interactive computing environment 1500 over a network 1506. Further, the no-code builder devices 1502 can include any type of computing system that enables a user (e.g., no-code builder) to interact with the no-code development system 1510 to build a no-code application. For example, the no-code builder devices 1502 may include a laptop, desktop, smartphone, client, set top box, gaming machine, Internet-of-Things (IoT) device, wearable computing device, and the like.

The application user devices 1504 may include any type of computing system that can communicate with the interactive computing environment 1500 over a network 1506. Further, the application user devices 1504 can include any type of computing system that enables a user (e.g., an end-user or customer) to execute a no-code application developed by a no-code builder. For example, the application user devices 1504 may include a laptop, desktop, smartphone, client, set top box, gaming machine, Internet-of-Things (IoT) device, wearable computing device, and the like. In some cases, a no-code builder device 1502 may also be an application user device 1504, and vice versa. Similarly, a no-code builder may be an end-user and vice versa.

The network 1506 may include any type of network or combination of networks. For example, the network 1506 may be a wireless network, a wired network, a cellular network, a wide area network, a local area network, and the like. Further, in some cases, the network 1506 may be or may include the Internet.

### Example Application Build Process

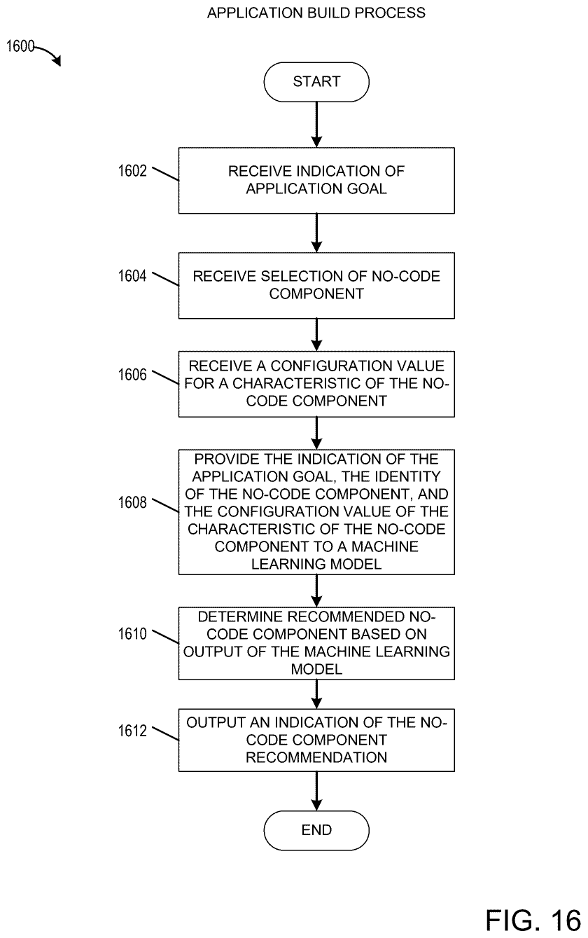

FIG. 16 presents a flowchart of a process 1600 corresponding to a non-limiting example application build process in accordance with certain embodiments. The process 1600 can be implemented by any system that can generate a no-code application (e.g., the application 1532) using recommendations generated by a prediction model 1562. The process 1600, in whole or in part, can be implemented by, for example, an interactive computing environment 1500, a no-code development system 1510, a user interface system 1514, an application generator 1512, a recommendation system 1560, an event tracking system 1540, and the like. Although any number of systems, in whole or in part, can implement the process 1600, to simplify discussion the process 1600 will be described with respect to particular systems.

The process 1600 may be performed each time a user begins a new application (e.g., creates an application under development 1516). The process 1600 may be performed when triggered by a user selection of a command at the start of generating a new application or at any time during development of the application. In some cases, the process 1600 may be performed automatically at particular time intervals during an application build process or upon indication that the application under development 1516 is completed (e.g., when a user selects to publish the application under development 1516).

The process 1600 begins at block 1602 where, for example, the no-code development system 1510 receives an indication of an application goal. The application goal may be for an application under development 1516. The application goal may indicate a purpose for the application or the type of application, which can include any type of application that can be executed by a computer. For example, the application type or purpose could be a digital storefront, a video game, a content hosting service, an information portal (e.g., an online wiki or encyclopedia), a database, a simulator, a design tool, etc. Alternatively, or in addition, the application goal can specify a characteristic of an application to improve. For example, the application goal may specify a computing resource whose usage is to be improved (e.g., reduce bandwidth use, reduce memory use, improve processor utilization efficiency, speed up execution, reduce latency, etc.). As another example, the application goal may specify a desire to improve retention of customers or end-users, increase conversion rate (e.g., percentage of users who become members of a service provided by the application, percentage of users that complete a purchase, etc.), improve user satisfaction with the application, and the like. In some cases, the block 1602 may include receiving an indication of multiple application goals.

The indication of the application goal may be received based on any type of user interface. For example, a user may answer a set of questions (e.g., via a wizard or other query feature), the user may select a goal from a list, the user may speak or type the goal via a chat interface, and the like. The user interface, e.g., the user interface system 1514, may use natural language processing or a large language model to determine the application goal based on user input.

In some embodiments, the application goals may be mapped as part of a set of key-value pairs that specify characteristics to improve (e.g., increase or reduce depending on the characteristic) based on the identified application goal. For example, application goals relating to resource utilization may map to values that correspond to lower resource utilization.

In some cases, the application goal may not be directly specified, but may be determined based on context information. For example, a user may indicate (e.g., verbally or via chat) frustration with responsiveness of the application and the no-code development system 1510 may determine based on the expressed frustration that a goal is to improve resource utilization of the application. As another example, a user may indicate a frustration with the lack of users and the no-code development system 1510 may determine that a goal it to improve a retention rate or a conversion rate of the application.

In some embodiments, the no-code development system 1510 may automatically determine the application goal based on included application features or included no-code components that have been added to the application under development 1516. For example, the inclusion of no-code components corresponding to a shopping cart, an image carousel, a shipping address user interface, and the like may indicate that the application is likely a product or services store or shopping website. The no-code development system 1510 may determine that a likely goal is to improve conversion rate or product browsing time. As another example, the inclusion of co-code components corresponding to controlling a location of images within data structure representing a map may indicate that the application under development 1516 is likely a video game and that an application goal may relate to performance improvements (e.g., reduced memory usage or increased frame rate) or to retention improvements. In certain embodiments, the application goal may be determined based at least in part on a similarity between the application under development 1516 and other applications that have been generated using the no-code development system 1510. In certain embodiments, the applications generated using the no-code development system 1510 may be used as training data by the prediction model training system 1570 to generate a prediction model 1562 that may be used to predict an application goal for the application under development 1516.

In some embodiments, the block 1602 is optional or omitted. For example, in some cases, the application purpose is used for improving an existing application and omitted when initially generating the application under development 1516.

At block 1604, the no-code development system 1510 receives a selection of a no-code component. The no-code component may be selected in response to a user interaction with the user interface system 1514. In some cases, the block 1604 may include selecting a plurality of no-code components. The no-code component may be an atomic component that corresponds to software code. Alternatively, the no-code component may be a super component or a component of components. In other words, in some cases, the no-code component may correspond to a plurality of no-code components that have been joined together to form a more complex no-code component. These super components may be no-code components generated by an entity that creates the no-code development system 1510 or generated by other users of the no-code development system 1510. Advantageously, by making no-code components available that have been created by users, the availability of different types of no-code components can increase over time providing more options for new users.

Receiving the selection of the no-code component can include receiving a number of types of metadata about the no-code component. Further, the selection of the no-code component, as well as associated metadata, can be added to the application playbook 1552. The metadata may include component library metadata corresponding to the built-in properties of each component. Non-limiting examples of the component library metadata may include security features and usability guidelines. For example, a no-code component that is a “Secure Login Button” may have metadata indicating that it is multi-factor authentication (MFA)-enabled (“MFA-enabled”) and designed for “High Security.”

Another example of metadata that may be received includes no-code builder actions. Events may be triggered whenever the no-code builder manipulates components, including drag-and-drop actions, deletions, or modifications. For example, if a “Standard Button” is dragged into the login UI of an application under development 1516, the action and the component's identifier may be recorded in the application playbook 1552.

In some cases, the metadata may include a builder profile that correspond to the no-code builder. The builder profile may include information about the builder's preferences, past behavior, and the sector within which the no-code builder is focused (e.g., healthcare, retail, entertainment, education, etc.). For example, if a no-code builder predominantly works on healthcare apps, the no-code builder may be flagged for prioritized security features, and no-code components that emphasize security features may be prioritized in providing suggestions or recommendations.

Yet another non-limiting example of metadata that may be received includes initial application layout data. The application layout data may include a location of where a no-code component is inserted within the “code” or design of the no-code application and/or within a user interface included as part of the no-code application. In some cases, the application layout data may include a template a no-code builder may choose that can include information about the placement and function of various no-code components. For example, in a shopping app blueprint, there may be a pre-defined area where the “Add to Cart” button is positioned on the user interface.

At block 1606, the no-code development system 1510 receives a configuration value for a characteristic of the no-code component. In some cases, the block 1606 may include receiving several configuration values for a characteristic and/or receiving configuration value(s) for several characteristics. Moreover, in some cases, the block 1606 may include receiving one or more configuration values for a plurality of no-code components.

The configuration value can include any type of value that is supported by a characteristic of the no-code component. Moreover, as different characteristics may support different types of values, the received configuration value may depend on the type of characteristic of the no-code component.

The characteristic of the no-code component may include any type of characteristic that describes the no-code component, its relation to other no-code components within the application under development 1516, or its relation to the application under development 1516 itself. Further, the characteristics supported by the no-code component may vary based on the type of no-code component.

For example, the characteristic may relate to a location of the no-code component within a user interface and the configuration value may be a location value. As another example, the characteristic may relate to a look or presentation of the no-code component (e.g., a color, a shape, a size, a translucence, etc.) and the configuration value may be a setting for the characteristic (e.g., a selection of the color, the shape, the size, the translucence, etc.). The aforementioned examples relate to visual characteristics of the no-code component. Alternatively, or in addition, the characteristic may relate to a parameter or control that modifies the operation or execution of the no-code component. For example, the characteristic may relate to how often an operation is performed (such as with a loop), under what condition an operation is performed (such as with a conditional statement), or what data may be processed by the no-code component. In some cases, the characteristic may include any feature or control that can modify the look and feel and/or operation of the no-code component.

At block 1608, the no-code development system 1510 provides the indication of the application goal, the identity of the no-code component, and/or the configuration value of the characteristic of the no-code component to the recommendation system 1560, which may include the prediction model 1562. This prediction model 1562 may be a machine learning model or may be generated using a machine learning process. In some embodiments, the no-code development system 1510 may provide more or less information to the recommendation system 1560 for providing as an input to the prediction model 1562. For example, in cases where the block 1602 is optional or omitted, the indication of the application goal may be omitted. As another example, the no-code development system 1510 may provide the identity of a plurality of no-code components and/or values for a plurality of characteristics of one or more no-code components to the recommendation system 1560 as an input to the prediction model 1562. The no-code development system 1510 may provide the information at the block 1608 to the prediction model 1562 by providing the information to the recommendation system 1560.

The prediction model 1562 may be a plurality of prediction models. The plurality of prediction models may be used as part of an ensemble learning process that combines the outputs of different types of prediction models to take advantage of the strength of different types of prediction models and to provide more accurate and robust recommendations compared to systems that rely on a single prediction model or a single type of prediction model. Further, the use of a plurality of prediction models may provide a diversity of learning mechanism that can provide broader insights about the input data. Moreover, the use of a plurality of prediction models is often more accurate than using a single model.

The output of the plurality of prediction models may be combined using any type of process for combining multiple values or predictions. For example, the output of the plurality of prediction models may be combined using an averaging process or a weighted averaging process that weights the outputs of different prediction models based on a desired objective and/or a confidence in the accuracy of a prediction generated by the prediction model. In some cases, the outputs of the prediction models are combined using a consensus strategy. For example, the no-code development system 1510 may select a prediction that corresponds to an output of the majority of the prediction models. As another example, the input may be provided a plurality of times to each prediction model, the output that occurs most frequently may be selected as the prediction or for combining with the outputs of the other prediction models.

The prediction model 1562, or one of the plurality of prediction models represented by the prediction model 1562, may include any type of prediction model that can provide a prediction of, or a recommendation of, a no-code component or a no-code component configuration value. For example, as previously described, the prediction model 1562 may include or be implemented using a support vector machine model, a random forest algorithm or classification, a deep neural network, a regression algorithm, or a clustering algorithm, among others. As indicated above, using an ensemble learning process that is based on using different prediction models can result in more accurate outputs because, for example, benefits unique to each model can be harnessed. For example, the support vector machine may be used to classify or predict based on hyperplanes in high-dimensional space and can be optimal for non-linear separation and to help prevent overfitting. A model based on random forest can be used to average predictions from multiple decision tress for more stable and accurate predictions that provides a balance between bias and variance, and can reduce overfitting. The deep neural network can be used to learn complex patterns from input data, can be nonlinear and can provide a probability output.

Each of the machine learning models used in the ensemble learning process may be used to predict or recommend no-code components or configurations of a no-code component based on different relationships within the training data. For example, consider the scenario where a no-code builder is creating a shopping cart feature and initially places a “Save for Later” button within the application under development 1516. The ensemble of machine learning models may assess real-time and historical data, along with application playbook 1552 patterns and natural language context, to determine that customers rarely come back to purchase “saved for later” items. Further, suppose that the application goal is to maximize sales or conversions. The prediction model 1562 may output a recommendation to replace the “Save for Later” button with a no-code component that implements a “Frequently Bought Together” panel to encourage immediate sales. In this example, the prediction model 1562 may be generated using ensemble learning as follows: a support vector model may focus on analyzing user demographics; a random forest model may focus on user behavior patterns; and a deep neural network may focus on relationships between user interactions with the application over time. The outputs may be combined using a consensus strategy (e.g., averaging, weighted averaging, majority selection, etc.) such that the ensemble learning or recommendation process provides a single recommendation tailored to achieve the specific application goal identified. The use of the ensemble learning process can in many cases result in more accurate recommendations for application building and/or improvement.

The prediction model 1562 may be trained based at least in part on previous or historical applications. These previous applications may be purposely generated for training by, for example, an entity that manages the no-code development system 1510. Alternatively, or in addition, the previous applications may be no-code applications created by previous users of the no-code development system 1510. In some cases, the prediction model 1562 may be trained based at least in part on previous iterations of the application under development 1516 or on variants of the application 1532.

At block 1610, the no-code development system 1510 determines a recommended no-code component based at least in part on an output of the prediction model 1562. The recommended no-code component may be a single component. Alternatively, the no-code development system 1510 may recommend a plurality of no-code components that may each be alternatives or may be used together as part of a larger no-code block. In some cases, the no-code development system 1510 may use the 1560 to determine the recommended no-code component. The recommended no-code component may be determined by the prediction model 1562 or may be determined based at least in part on an output of the prediction model 1562.

The recommended no-code component may be a no-code component to add to the application under development 1516. Further, the recommended no-code component may be recommended for use in conjunction with the no-code component identified at the block 1604 or to be included in another part of the application under development 1516. For example, if the no-code component selected at the block 1604 is a shopping cart, the recommended no-code component may be associated with credit-card processing, which may be connected to the shopping cart within the application under development 1516. Alternatively, the recommended no-code component may be associated with displaying a video, which may or may not be related to the shopping cart.

The recommended no-code component may be a component that is often used together with the no-code component identified at the block 1604. Alternatively, the no-code component may be a component that is often used as a substitute for the no-code component identified at the block 1604. In some such cases, the recommended no-code component may be recommended as a substitute for the no-code component identified at the block 1604.

In some embodiments, the block 1610 may recommend a no-code component configuration. This no-code component configuration may be a value for a characteristic of the no-code component. The recommended configuration may be for the no-code component identified at the block 1604 or for a separate no-code component that is part of the application under development 1516 or that is recommended by the recommendation system 1560.

At block 1612, the no-code development system 1510 outputs an indication of the no-code component recommendation. Outputting the indication of the no-code component recommendation may include displaying an identity of a recommended no-code component or no-code component configuration via the user interface system 1514. This recommendation may be displayed at a no-code builder device 1502. Alternatively, or in addition, outputting the indication of the no-code component recommendation may include implementing the no-code component recommendation as part of the application under development 1516. In other words, the no-code development system 1510 may automatically apply the recommendation to the application under development 1516 by, for example, inserting a no-code component into the no-code (e.g., onto the application canvas or workspace) of the application under development 1516.

### Example Application Refinement Process

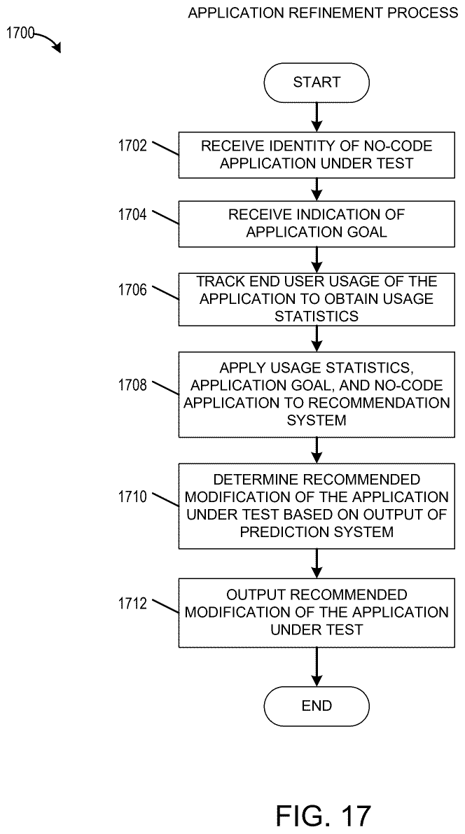

FIG. 17 presents a flowchart of a process 1700 corresponding to a non-limiting example application refinement process in accordance with certain embodiments. The process 1700 can be implemented by any system that can modify or suggest a modification to a no-code application (e.g., the application 1532) using recommendations generated by a prediction model 1562. The process 1700, in whole or in part, can be implemented by, for example, an interactive computing environment 1500, a no-code development system 1510, a user interface system 1514, an application generator 1512, a recommendation system 1560, an event tracking system 1540, and the like. Although any number of systems, in whole or in part, can implement the process 1700, to simplify discussion the process 1700 will be described with respect to particular systems.

The process 1700 may be automatically implemented on a continuous or intermittent basis. Alternatively, or in addition, the process 1700 may be triggered by a user request. In some cases, the process 1700 is performed on a scheduled basis, such as once a year for each application hosted by the interactive computing environment 1500. In some cases, the process 1700 is performed more frequently when an application 1532 is first published and then performed less frequently over time. In some cases, the process 1700 may be repeated each time an update to an application 1532 is published.

The process 1700 begins at block 1702 where, for example, the no-code development system 1510 receives an identity of a no-code application under test. The no-code application under test may include any no-code application managed or maintained by the interactive computing environment 1500. For example, the no-code under test may be the application 1532. Although typically the application processed by the process 1700 is a completed or published application, in some cases, an application under development 1516 may be identified at the block 1702.

In some cases, the no-code application under test may be selected by a user for refinement. In other cases, the process 1700 may be performed automatically for some or all applications maintained or managed by the interactive computing environment 1500. In some such cases, the no-code application under test may be automatically selected or scheduled for the process 1700 without user interaction or selection.

At block 1704, the no-code development system 1510 receives an indication of an application goal. The block 1704 may include one or more of the embodiments described with respect to the block 1602.

At block 1706, the no-code development system 1510 tracks end-user usage of the application under test to obtain usage statistics. The no-code development system 1510 may use the event tracking system 1540 to track the usage statistics. The event tracking system 1540 may track usage statistics through the execution tracker 1534 inserted in the application 1532. The usage statistics may relate to any type of interaction by a user with respect to the application 1532. For example, the usage statistics may indicate user interface elements accessed by the user, an amount of time accessing the application 1532, tasks completed by the user using the application 1532, or any other type of use of the application 1532. The user interactions may be via a user interacting with a user interface system 1522 using an application user device 1504.

In some cases, the usage statistics may relate to computing resources used by the application 1532. For example, the usage statistics may indicate a latency value, a processor utilization value, a memory usage value, and the like. Moreover, in some cases, the usage statistics may include data obtained via user query, such as a user review rating, a user satisfaction level, user feedback data, etc.

The usage statistics may be obtained from one user or from a plurality of users. Further, the usage statistics may be obtained from one version of the application 1532. Alternatively, the usage statistics may be obtained from a plurality of versions of the application 1532 enabling a comparison of results from the different version of the application 1532. This comparison of results may be performed by the prediction model 1562 either explicitly or inherently as part of the processing performed by the prediction model.

In some cases, the usage data may include the application playbook 1552 or may be stored in the application playbook 1552. In such cases, the block 1706 may include accessing the application playbook 1552 from the database 1550.

In certain embodiments, the process 1700 collects a number of different run-time inputs that may be used to generate a recommended modification to the application 1532 (e.g., as part of the block 1710 discussed below) and/or to update training data that may be used as part of the process 1800 discussed below. These run-time inputs may include any type of input that can be used to generate a recommendation that improves operation or development of an application. Some non-limiting examples of the run-time inputs may include no-code component identifiers, positional data, user-behavior metrics, and context and/or application goals. The no-code component identifiers may include unique identifiers for each no-code component that may be used by the no-code development system 1510, the application playbook 1552, the event tracking system 1540, or the recommendation system 1560 to recognize which application elements with which a user (e.g., a developer or end-user) or system is interacting. Positional data may include location information or coordinates (e.g., cartesian coordinates) of a no-code component within an application window. For example, if a user interface button is at the top-right corner of a window, its positional data may be (x=900, y=20). Further, it should be understood that location information is not limited to two-dimensional (2D) space. For example, suppose the application 1532 is a video game or an educational application that presents a three-dimensional (3D) world. In such cases, the positional data may include location information for items within the 3D world (e.g., x=500, y=500, z=600). This location information may be used during the building process (e.g., process 1600), the modification process (e.g., process 1700), or the training process (e.g., 1800).

In some cases, a no-code builder can develop applications within a 3D development environment (e.g., a metaverse). For example, a no-code builder may wear virtual reality equipment while developing an application enabling the no-code builder to view the application canvas and/or a user interface developed using the no-code development system 1510. In some such cases, the no-code builder can design an application by dragging and dropping (or using any other means of interaction) 3D components in the 3D building environment. The no-code development system 1510 may implement the same approach and systems, including the same prediction model 1562, to develop 3D applications and environments as with the 2D applications and environments.

User behavior metrics may include actions or interactions by a user (e.g., an end-user) with an application element, such as clicks, scrolls, or time spent interacting with certain application elements, which may correspond to one or more no-code components. These inputs may include, “time on page,” “time interacting with element,” and the like, which could be measured as numerical value (e.g., 240 seconds) and which can be used to quantify user engagement. Context and/or application goals may include flags or tags specifying the purpose of the application and a particular goal for which improvement is desired. For example, a goal may be to improve resource utilization, which may affect how the no-code development system 1510 or the recommendation system 1560 prioritizes certain features or no-code components in generating a recommendation.

Inputs may be shared across the processes 1600, 1700 and 1800. These inputs may be shared inherently via the application playbook 1552. As described previously, the application playbook 1552 may log events. These logged events may include any type of interaction during the development or use of an application 1532. In some cases, the logged events may align with predefined rules or guidelines associated with design-time, run-time, or both. For example, a design-time playbook event could suggest, “Component BTN_002 not recommended for healthcare apps,” while a run-time event could log an interaction with that no-code component, flagging it for review or used to trigger the next component suggestion.

Further, the inputs may be used to enable a feedback loop between design-time and run-time and/or between future uses of the no-code development system 1510. For example, user feedback and system performance data collected at run-time can become inputs for future design-time decisions. For instance, if a “Save for Later” button is infrequently used, this feedback could trigger a design-time recommendation suggesting removal or modification of the button.

At block 1708, the no-code development system 1510 applies the usage statistics, the application goal, and the no-code application under test to the recommendation system 1560, or the prediction model 1562. Applying the usage statistics and the no-code application under test to the recommendation system 1560 may include applying different set pairs of usage statistics and application versions to the recommendation system 1560.

At block 1710, the no-code development system 1510 determines a recommended modification of the application under test based at least in part on an output of the recommendation system 1560, or the prediction model 1562. The recommended modification may be to replace one or more no-code components with one or more other no-code components. The replacement of one or more no-code components may result in additional changes to the application 1532. For example, the recommendation may be to replace a user interface element that permits a user to scroll a window up or down to see a set of images with a user carousel user interface element. This recommendation may be based on a determination or prediction that user satisfaction is higher with applications that depict images using a carousel element. As another example, the recommendation may be to replace one or more no-code components corresponding to one or more FOR loops with one or more no-code components that correspond to one or more WHILE loops. This recommendation may be based on a determination or prediction that replacing one type of loop with another type of loop will improve the speed of execution of the application 1532.

Alternatively, or in addition, the recommended modification may be to modify one or more characteristics or features of one or more no-code components. For example, the recommended modification may be to change a configuration value of a no-code component that causes a change in location of a user interface element within a user interface. This recommendation may be based on a determination or prediction that changing the location of the user interface element will increase user satisfaction and/or conversion rate. As another example, the recommended modification may result in a change in color of a user interface element based on a prediction that a color change will make the application more user friendly for those with certain disabilities.

In some embodiments, the block 1710 may include identifying several no-code components. In some cases, each of the identified no-code components may be scored and/or ranked based on a likelihood that the no-code components will improve a characteristic of the application 1532 corresponding to the application goal. In some cases, the recommended modification may be to make no modification to the application 1532 because, for example, the application 1532 is determined to be optimal for the selected application goal or because a modification is unlikely to result in more than a threshold level of improvement with respect to the selected application goal. It should be understood that in cases where the recommendation is no modification, it is possible a modification would be recommended if the application goal is changed or if additional training data is supplied to the prediction model training system 1570 resulting in a change to the prediction model 1562.

At block 1712, the no-code development system 1510 outputs the recommended modification of the application under test. Outputting the recommended modification may include presenting one or more recommended modification options to a user enabling the user to select an option. Alternatively, or in addition, outputting the recommended modification of the application 1532 may include automatically implementing the recommended modification. In some cases, the specific modification is identified to the no-code builder that developed the application 1532 or that is managing the application 1532 at the interactive computing environment 1500. In other cases, the modifications are not identified but are automatically implemented based on the desired application goal.

In some embodiments, the recommended modifications and/or usage statistics associated with the recommended modifications are supplied as training data to the prediction model training system 1570 enabling the prediction model 1562 to be updated. Thus, a feedback system may be implemented that improves both the applications developed using the no-code development system 1510 as well as the prediction model 1562 used to help create or update applications 1532. Advantageously, the feedback system provides an adaptive learning process that helps improve recommendations over time as the interactive computing environment 1500 is used to develop applications and/or to interact with generated applications.

### Example Recommendation Model Training Process

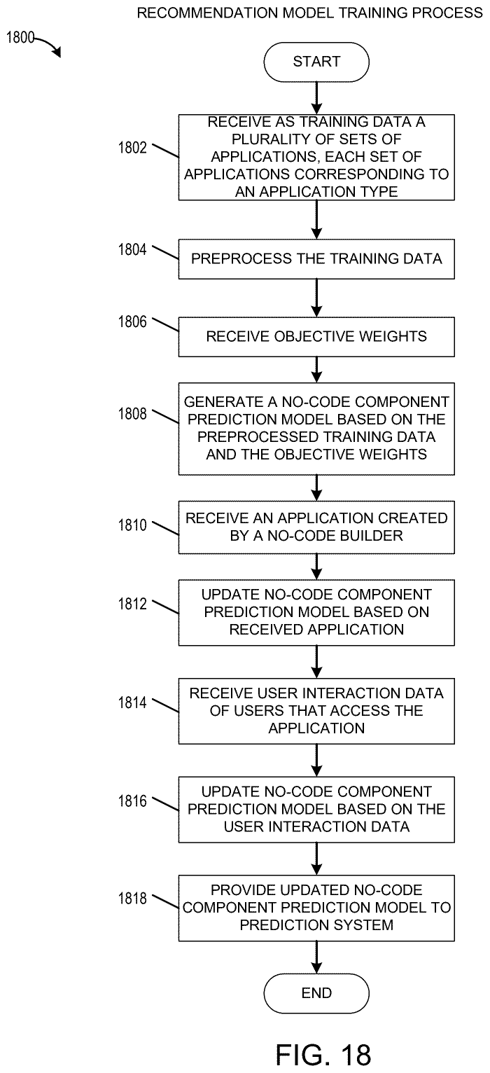

FIG. 18 presents a flowchart of a process 1800 corresponding to a non-limiting example recommendation model training process in accordance with certain embodiments. The process 1800 can be implemented by any system that can train a prediction model 1562 for recommending a no-code component or a configuration of a no-code component. The process 1800, in whole or in part, can be implemented by, for example, an interactive computing environment 1500, a no-code development system 1510, a user interface system 1514, an application generator 1512, a recommendation system 1560, an event tracking system 1540, a prediction model training system 1570, and the like. Although any number of systems, in whole or in part, can implement the process 1800, to simplify discussion the process 1800 will be described with respect to particular systems.

In some embodiments, the process 1800 is used to train one or more machine learning models. In other embodiments, the process 1800 may be used to refine or fine tune previously generated machine learning models. For example, the prediction model 1562 may be generated and/or trained using prior applications or historical data. This historical data may be applications generated using the interactive computing environment 1500 or may be other applications or data used to create an initial prediction model 1562. Using the process 1800, the prediction model 1562 can be refined or fine-tuned to generate recommendations for the no-code development system 1510.

The process 1800 begins at block 1802 where, for example, the prediction model training system 1570 receives, as training data, a plurality of sets of applications. Each set of applications may correspond to a particular application type. Further, at least some of the training data (e.g., applications) may include templates and/or may be specifically generated by, for example, an entity that controls the interactive computing environment 1500. In some such cases, the training data may include recorded explanations and/or labels of a purpose for each no-code component and/or application to facilitate training of the prediction model 1562. In some cases, at least some of the training data may include applications 1532 created by one or more no-code builders or customers of the no-code development system 1510.

The training data may be obtained from the application playbook 1552. Thus, in some cases, the block 1802 may include accessing the application playbook 1552 from the database 1550.

In some cases, at least some of the training data may include labelled data. For example, applications included in the training data may be labelled with the type of application. Further, the applications included in the training data may be labelled to indicate whether they are good or bad implementations with respect to one or more desirable or undesirable characteristics of the applications. For instance, applications that use excessive memory may be labelled as memory inefficient while applications that are efficient in their use of memory may be labelled as memory efficient. Further, labels are not limited to binary labels but may indicate a gradient or value within a range for a characteristic, such as resource utilization or user satisfaction.

At block 1804, the prediction model training system 1570 preprocesses the training data. Preprocessing the training data can include one or more of a number of different processes. These processes may include any type of process that removes outliers, converts the training data into a consistent form, and/or converts the training data into a form understood by the prediction model training system 1570. For example, the prediction model training system 1570 may preprocess training data to remove or filter null or missing values within the training data, or to remove training data that includes missing values. As another example, the prediction model training system 1570 may remove or filter extreme values that might excessively influence a decision of a model generated by the prediction model training system 1570. Extreme values may include values that are a particular number of standard deviations away from the mean or that are one or more magnitudes different from the average value for a particular feature. In some cases, extreme values may be any value above or below a particular threshold.

Preprocessing the training data may further include validating the training data. Validating the training data may include determining whether the training data satisfies a set of criteria. This criteria may be specific to the type of prediction model 1562 to be generated. For example, the desired prediction model 1562 may be for a certain type of application (e.g., video streaming, shopping, data delivery, etc.) or for improving a particular feature or characteristic (e.g., memory usage, speed, user retention, etc.) of an application. In some such cases, the training data may be validated to determine whether it relates to the desired type of application or feature to be improved.

In some implementations, the preprocessing of training data may include scaling, normalizing, or other data transformations. The data transformation may be used to ensure consistency in data format or types of data provided to the prediction model training system 1570 for training the prediction model 1562. Normalizing the data may include performing min-max scaling. The data can be scaled so that all the values are within a specific range, such as 0 to 1. Scaling the data may ensure that no particular feature dominates others during the learning process. Further, scaling the data can be useful when dealing with diverse metrics like user satisfaction scores, latency times, etc.

Further, the preprocessing of training data may include transforming heterogenous data into a homogenous format. Further, the transformation of the data may include converting data to a format that can be processed by the prediction model 1562 or the prediction model training system 1570 to train the prediction model 1562. For example, the prediction model training system 1570 may convert the training data using one-hot encoding. For instance, categorical variables, such as different types of user feedback or application variants, may be converted into a numerical format using one-hot encoding. This transformation allows the prediction model 1562 (e.g., a neural network) to process the categorial variables as distinct values without an arbitrary ordering.

The filtered, normalized, and/or transformed data may serve as input to the prediction model 1562 (e.g., a deep neural network) as part of the training process. The training data may be used to train the machine learning model to accurately learn the relationships within the data, leading to more effective recommendations for improvements and adaptations in the no-code application (e.g., application under development 1516 or application 1532).

At block 1806, the prediction model training system 1570 receives objective weights. The objective weights may include features or criteria of an application under development to improve. In some cases, the objective weights correspond to a desired application goal. In some cases, there may be multiple objectives that the prediction model 1562 is used to help improve. In such cases, the objectives may be associated with weights indicating their relative importance. These weights may be the same for objectives of equal importance or may vary for objectives of differing importance. Non-limiting examples of objective may include load time, user satisfaction, bug or error frequency, resource utilization (e.g., processor, memory, bandwidth, etc.), user retention, transaction conversion, time-to-completion of an objective (e.g., completion of a form, purchase transaction, data entry, etc.), and any other objective that may be accomplished by an application or relating to the execution of an application. In some embodiments, the block 1806 may be optional or omitted.

At block 1808 the prediction model training system 1570 generates a no-code component prediction model (e.g., the prediction model 1562) based at least in part on the preprocessed training data and, in some cases, the objective weights. Alternatively, or in addition, the prediction model training system 1570 refines an existing prediction model using the preprocessed training data and/or the objective weights. In some embodiments, the operations associated with the block 1808 are performed once as part of the process 1800. Alternatively, operations associated with the block 1808 may occur intermittently or continuously. For example, the prediction model training system 1570 may generate, or update, the no-code component prediction model (e.g., the prediction model 1562) as more training data is received or applied to the training model. Advantageously, by continuing to generate or update the prediction model 1562, the prediction model 1562 can be improved over time as more training data becomes available.

Generating the no-code component prediction model may include generating one model, or a plurality of models. Different prediction models may be generated for different application types and/or different objectives. Further, different prediction models may be generated based on different types of machine learning models. Thus, the prediction model 1562 may be or may include multiple prediction models. By generating different prediction models using different types of machine learning models, an ensemble learning process can be implemented. Advantageously, as described with respect to the block 1608, an ensemble learning process enables the no-code development system 1510 to take advantage of the different advantages offered by different types of machine learning models. The outputs of the different models may be evaluated separately to generate a prediction, or may be combined using consensus strategies, with or without weighting to prioritize particular models, to generate the prediction or recommendation. Non-limiting types of machine learning models that may be used to generate the one or more prediction or recommendation models include support vector machine models, random forest models, deep neural network models, and the like.

In certain embodiments, the process 1800 may end after the completion of the operations associated with the block 1808. In other embodiments, the process 1800 may continue to, for example, update the prediction model 1562 based on additional training data or other captured data that may be used for training purposes to update the prediction model 1562.

At block 1810, the prediction model training system 1570 receives an application created by a no-code builder. This received application may be a completed application, such as the application 1532, or an application under development, such as the application under development 1516. In some cases, receiving the application may include receiving an identity of the type of application (e.g., a purpose for the application, or a summary of tasks performed by the application, or a classification of the application, etc.). For example, the type of application could be an entertainment application, a video game, a shopping application, an information delivery application, an educational application, a simulator, a design application, a word processing application, a spreadsheet application, a database application, and the like.

At block 1812, the prediction model training system 1570 updates the no-code component prediction model (e.g., the prediction model 1562) based at least in part on the received application received at the block 1810. Updating the no-code component prediction model may include supplying the received application as training data to the prediction model 1562. In some cases, the received application may reinforce the prediction model 1562 generated at the block 1808. In other cases, the use of the received application as training data may result in changes to the prediction model 1562.

At block 1814, the prediction model training system 1570 receives user interaction data of users that access the application received at the block 1810. In some embodiments, the user interaction data is received by accessing the application playbook 1552 from the database 1550. The application playbook 1552 may have an indication of interactions used to generate the application 1532 and/or interactions with the application 1532 by, for example, end-users via the application user devices 1504. Each interaction in building the application and/or in interacting with the application can be events in the application playbook 1552. Each event may define the type of interaction, the state of the application during the interaction, the timing of the interaction, and any other information that can be captured by a user interaction with he no-code development system 1510 and/or the application 1532.

In some embodiments, receiving user interaction data may also include receiving metadata relating to operation or implementation of the application 1532. For example, the block 1814 may include receiving bug reports, system resource utilization data, user ratings, and the like.

At block 1816, the prediction model training system 1570 updates the no-code component prediction model (e.g., the prediction model 1562) based at least in part on the user interaction data received at the block 1814. The block 1816 may include one or more of the embodiments described with respect to the block 1812 using the interaction data as input instead of or in addition to the no-code application received at the block 1810.

At block 1818, the prediction model training system 1570 provides the updated no-code component prediction model to a prediction system, such as the recommendation system 1560. The recommendation system 1560 can use the updated no-code component prediction model to generate recommendations relating to selection of no-code components, replacement of no-code components, configuration of no-code components, or any other recommendation that can be used to facilitate building or improving a no-code application.

Data received as part of the training process may include labelled data, unlabeled data, or a combination of labelled and unlabeled data. In some cases, the training data received as the block 1804 may include labelled data that is labelled by the users or systems that generate the training data. While additional data used for training after the initial training of the prediction models (e.g., data obtained at the block 1810 or the block 1814) may be unlabeled data that is obtained after initial generation of the prediction models and used to update the prediction models.

In some cases, the labels may correspond to no-code components or to no-code applications. The labels may indicate the type of application, the use for the no-code component, the affect of the no-code component(s) on the application (e.g., whether a configuration of the no-code component increase user engagement or user satisfaction, or decreased resource utilization, etc.), or any other characteristic relating to the use of or configuration of a particular no-code component.

### Terminology

Conditional language used herein, such as, among others, “can,” “could,” “might,” “may,” “e.g.,” and the like, unless specifically stated otherwise, or otherwise understood within the context as used, may be generally intended to convey that certain embodiments include, while other embodiments do not include, certain features, elements and/or states. Thus, such conditional language may be not generally intended to imply that features, elements and/or states may be in any way required for one or more embodiments or that one or more embodiments necessarily include these features, elements and/or states.

Conjunctive language such as the phrase “at least one of X, Y, and Z,” unless specifically stated otherwise, may be otherwise understood with the context as used in general to convey that an item, term, etc. may be either X, Y, or Z. Thus, such conjunctive language may be not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Additionally, features described in connection with one embodiment can be incorporated into another of the disclosed embodiments, even if not expressly discussed herein, and embodiments may have the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it may be intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example may be to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps may be mutually exclusive. The protection may be not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

Moreover, while operations may be depicted in the drawings or described in the specification in a particular order, such operations need not be performed in the particular order shown or in sequential order, or that all operations be performed, to achieve desirable results. Other operations that may be not depicted or described can be incorporated in the example methods and processes. For example, one or more additional operations can be performed before, after, simultaneously, or between any of the described operations. Further, the operations may be rearranged or reordered in other implementations, including being performed at least partially in parallel. Those skilled in the art will appreciate that in some embodiments, the actual steps taken in the processes illustrated and/or disclosed may differ from those shown in the figures. Depending on the embodiment, certain of the steps described above may be removed, others may be added.

For purposes of this disclosure, certain aspects, advantages, and novel features may be described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that may be within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure may be not intended to be limited by the specific disclosures of preferred embodiments in this section or elsewhere in this specification, and may be defined by claims as presented in this section or elsewhere in this specification or as presented in the future. The language of the claims may be to be interpreted broadly based on the language employed in the claims and not limited to the examples described in the present specification or during the prosecution of the application, which examples may be to be construed as non-exclusive.

Unless the context clearly may require otherwise, throughout the description and the claims, the words “comprise”, “comprising”, and the like, may be construed in an inclusive sense as opposed to an exclusive or exhaustive sense, that may be to say, in the sense of “including, but not limited to”.

What is claimed:

1. A no-code development system configured to recommend a no-code component to a user during development of an application, the no-code development system comprising:
a non-volatile memory configured to store an application playbook comprising a set of coding events; and
a hardware processor in communication with the non-volatile memory, the hardware processor configured to:
receive an indication of a no-code component being added to an application canvas;
add the indication of the no-code component to the application playbook as a coding event, wherein the coding event corresponds to a creation of a portion of the application without the user writing source code;
apply the application playbook to a component prediction model to identify a second no-code component, wherein the component prediction model comprises a machine-learning based prediction model configured to identify no-code components based at least in part on a portion of an application under development;
output an identification of the second no-code component to the user;
receive a selection of the second no-code component; and
add an instance of the second no-code component to the application canvas.

2. The no-code development system of claim 1, wherein the second no-code component is an instance of the no-code component, and wherein the identification of the second no-code component comprises an identification of a configuration of a parameter of the no-code component.

3. The no-code development system of claim 1, wherein the hardware processor is further configured to receive an indication of a purpose of the application, and wherein applying the application playbook to the component prediction model further comprises applying the indication of the purpose of the application to the component prediction model.

4. The no-code development system of claim 1, wherein adding the instance of the second no-code component to the application canvas comprises replacing the no-code component with the second no-code component.

5. The no-code development system of claim 1, wherein the hardware processor is further configured to:
add the indication of the second no-code component to the application playbook to obtain an updated application playbook;
apply the updated application playbook to the component prediction model to identify a third no-code component; and
output an identification of the third no-code component to the user.

6. The no-code development system of claim 5, wherein, in response to receiving an indication that the third no-code component was not selected to add to the application canvas, the hardware processor is further configured to modify the updated application playbook to indicate the non-selection of the third no-code component.

7. The no-code development system of claim 1, wherein the component prediction model is trained based at least in part on previously created applications created using the no-code development system.

8. A no-code development system configured to modify a no-code application, the no-code development system comprising:
a non-volatile memory configured to store computer-executable instructions; and
a hardware processor in communication with the non-volatile memory and configured to execute the computer-executable instructions to at least:
receive an identity of a no-code component;
receive a configuration value for a characteristic of the no-code component, wherein the characteristic corresponds to operation of the no-code component or a location of the no-code component within the no-code application;
using a prediction model, determine a recommended no-code component based at least in part on the identity of the no-code component and the configuration value; and
output an indication of the recommended no-code component.

9. The no-code development system of claim 8, wherein outputting the indication of the recommended no-code component comprises outputting an indication of the no-code component on a user interface for display to a user.

10. The no-code development system of claim 8, wherein outputting the indication of the recommended no-code component comprises automatically replacing the no-code component with the recommended no-code component within the no-code application without action by a user.

11. The no-code development system of claim 8, wherein the recommended no-code component comprises a different no-code component than the no-code component.

12. The no-code development system of claim 8, wherein the recommended no-code component comprises an instance of the no-code component with a different configuration value for the characteristic of the no-code component.

13. The no-code development system of claim 8, wherein the prediction model is trained using at least a plurality of no-code applications.

14. The no-code development system of claim 8, wherein the hardware processor is further configured to execute the computer-executable instructions to at least receive an indication of an application goal of the no-code application.

15. The no-code development system of claim 14, wherein the recommended no-code component is further determined based at least in part on the application goal.

16. The no-code development system of claim 14, wherein the hardware processor is further configured to execute the computer-executable instructions to at least access usage statistics of the no-code application.

17. The no-code development system of claim 16, wherein the usage statistics are obtained from an application playback configured to track events corresponding to interaction with the no-code application.

18. The no-code development system of claim 16, wherein the usage statistics are obtained by tracking interaction with the no-code application over a time period.

19. The no-code development system of claim 16, wherein the hardware processor is further configured to execute the computer-executable instructions to at least recommend a modification to the no-code component based at least in part on the application goal and the usage statistics.

20. The no-code development system of claim 19, wherein the modification to the no-code component comprises a modification to the configuration value of the no-code component.

21. The no-code development system of claim 19, wherein the modification to the no-code component comprises an identity of a replacement no-code component for the no-code component.

22. The no-code development system of claim 16, wherein the hardware processor is further configured to execute the computer-executable instructions to at least update training of the prediction model based at least in part on the usage statistics.

23. The no-code development system of claim 8, wherein the location of the no-code component within the no-code application corresponds to a location within a user interface of the no-code application.

24. The no-code development system of claim 8, wherein the prediction model comprises a plurality of prediction models.

25. The no-code development system of claim 24, wherein determining the recommended no-code component comprises:
obtaining a set of prediction values the plurality of prediction models, wherein the set of prediction values comprises at least one prediction value from each prediction model of the plurality of prediction models;
determining a consensus prediction value based at least in part on the set of prediction values; and
determining the recommended no-code component based at least in part on the consensus prediction value.

26. The no-code development system of claim 24, wherein each prediction model is generated using a different machine learning model.

27. The no-code development system of claim 8, wherein the prediction model is generated based at least in part on training data corresponding to a set of no-code applications and a set of objective weights corresponding to one or more applications goals.
